(19) United States
(12) Patent Application Publication
(10) Pub. No.: US 2025/0094980 A1
(43) Pub. Date: Mar. 20, 2025

(54) SYSTEMS AND METHODS FOR DATA PROCESS INTEGRATION

(71) Applicant: ROYAL BANK OF CANADA, Toronto (CA)

(72) Inventors: Timothy Dean MCGAUGH, Toronto (CA); Katherine MAW, Toronto (CA); Arnold BADAL-BADALIAN, Toronto (CA); Manu KHULLAR, New York, NY (US); Edison U. ORTIZ, Orlando, FL (US); Francis LI, Toronto (CA)

(21) Appl. No.: 18/892,197

(22) Filed: Sep. 20, 2024

Related U.S. Application Data
(60) Provisional application No. 63/539,457, filed on Sep. 20, 2023.

(51) Int. Cl. G06Q 20/40; G06Q 20/38

(52) U.S. Cl. CPC G06Q 20/401; G06Q 20/3821; G06Q 2220/00

(57) ABSTRACT

An improved approach is proposed for data process integration using point of sale computing devices where the point of sale devices are adapted to interoperate with third party remote servers hosting third party remote databases through application programming interfaces exposed as between the point of sale devices and access to the third party remote servers. A data communications protocol is proposed for establishing secure network connections for the flow of secure messaging between the point of sale devices and the third party remote servers. Latency-based communication channels and asynchronous processing are proposed based on cybersecurity sensitivity levels of specific communication flows.

### CROSS-REFERENCE

This application is a non-provisional of, and claims all benefit from, including priority to, U.S. Application No. 63/539,457, filed 20 Sep. 2023, entitled SYSTEMS AND METHODS FOR DATA PROCESS INTEGRATION, incorporated herein by reference in its entirety.

### FIELD

Embodiments of the present disclosure relate to the field of secure inter-process data communications, and more specifically, embodiments relate to devices, systems and methods for data process integration and corresponding computer architecture.

### INTRODUCTION

Point of sale/payment terminals are a useful computing tool that can be distributed around different physical premises. Point of sale/payment terminals are computing devices that have streamlined computing functionalities and displays. Some point of sale terminals have buttons or interactive displays such that a user is able to provide inputs to the point of sale terminal.

An example use case for a point of sale device is use as a cashier terminal where a cashier processes a payment by a customer at a store by inputting transaction information at the time of purchase and also receiving a data communication corresponding to payment information. When the payment is complete, a receipt can be generated.

Point of sale device/payment terminals can be stand alone or integrated into larger payment systems. Typically, point of sale device terminals can be used exclusively as portable electronic devices for processing payment. As standalone point of sale device/payment terminal capabilities evolve, distributed processing can allow services usually only available on larger point of sale systems.

Point of sale/payment terminals, however, are a point of cyber security vulnerability and thus have interface limitations and limited capabilities. Further, point of sale/payment terminals may have limited computer processor resources as it is important to inexpensively deploy a large number of point of sale terminals at scale. Point of sale/payment terminals are also limited to operations for a particular merchant and their capabilities to communicate with outside devices such as third party software or computers is intentionally limited due to cyber security risk.

An objective described in approaches herein is to securely enhance the capability of the point of sale/payment terminal device terminals to provide improved system capabilities, which has the effect of enabling smaller retailers with less computing infrastructure to cost effectively access enhanced capabilities.

As described herein, it can be technically challenging to interoperate with point of sale/payment terminal devices where computer interactions are required outside of the secure merchant ecosystem. These technical challenges include being able to provide a responsive experience despite limited computing resources and the need for secure messaging.

### SUMMARY

An improved approach is proposed for data process integration using point of sale computing devices where the point of sale devices are adapted to interoperate with third party remote servers hosting third party remote databases through application programming interfaces exposed as between the point of sale devices and access to the third party remote servers. A data communications protocol is proposed for establishing secure network connections for the flow of secure messaging between the point of sale devices and the third party remote servers. The third party remote servers can be used to provide extended functionality, such as value-added services, loyalty rewards programs, among others, which are accessible through data messages sent through corresponding application programming interfaces. The extended functionality can, in some embodiments, include specific user interface control instruction data sets such as style sheets or visual iconography elements, font preferences, color control, among others.

The point of sale computing devices can be used at a merchant location or on merchant premises, such as a store. The user of the point of sale computing devices can be a merchant user such as an employee, who configures the point of sale computing device for receiving a payment card or “tap” (e.g., near field communications message exchange) from a customer.

When the customer pays through insertion, tap, or other means of exchanging the payment data messages, an improvement provided by the present described embodiments is that the user is able to use a single “tap” or insertion to not only pay, but it also automatically triggers workflows (if the merchant is enrolled) where the third party remote servers are interrogated to assess whether the user can make a partial payment or a full payment using credits or “points” stored on records thereon in a next screen or through the user interface. This is an enhanced functionality as the system can automatically check for the availability of points without having to do a second “tap”, insertion or entering of a phone number or email associated with their points account. Effectively, the system initiates a messaging process on the first contact that does the heavy lifting of interactions such that the user experience does not substantively get worse as they do not have to separately provide identification about their enrollment in a loyalty program. However, this can be difficult to practically implement because the third party remote servers and databases are outside of a secure ecosystem of the point of sale device, and additional electronic connections are needed.

Enrollment in this extended functionality can happen, for example, on a backend platform that the merchant can use to set up the point of sale computing device. For example, the backend platform can have user interface elements for setting aspects such as automatic addition of tax, which card types to accept, setting up of automatic gratuity buttons, etc. Additionally, the backend platform can include options for setting up third party remote server connections for extended functionality, and during this set up process, data messages including cryptographic keys may be communicated. In another variation, the cryptographic keys are generated in a key generation ceremony, for example, using nonces and setting up cryptographic seeds. The cryptographic keys can be used for secure communications.

To provide this extended functionality, the point of sale computing devices utilize improved communication protocols to securely engage the external application programming interfaces. A data process exchanging data messages can be used for authenticating an identify of a user, and these messages can be provided, for example, in a payment data cryptogram representing a payment token data structure when presented by a user at the time of payment. The payment token data structure includes at least one data field indicative of a linkage with the third party remote database. The third party remote database can, for example, store one or more data records corresponding to one or more alternative payment options, and these could be representations of various point balances accrued for a user, or representations of available promotions coupled to the user's profile in the third party remote database. The extended functionality requires additional technical implementation as these aspects cannot be handled using an existing protocol.

After validation of the customer's profile through communication of secure messaging with an application programming interface of the third party remote database, a confirmed enrollment and an availability of the one or more alternative payment options on the one or more data records can be determined. The enrollment for example, could be a positive identification of an account associated with the user, and the availability of the one or more alternative payment options can be a determination of a positive credit balance associated with that account greater than a minimum threshold. The third party remote database, upon this determination, may send and encrypted datagram to the point of sale computing device. This encrypted datagram could be part of an initial handshake process.

The display of the point of sale computing device then can be controlled for rendering, on a electronic display screen, interactive graphical user interface controls corresponding to the one or more alternative payment options and providing a prompt for a user to select either a partial payment or a full payment using the one or more alternative payment options. As noted above, an important factor to consider is that the extended functionality to use alternative payment options, such as “pay by points”, is established with a single tap of a payment card by the customer.

Accordingly, the customer may be able to indicate that part or all of the payment can be made by debiting the user's credit balance of reward points, for example. The user can indicate this through a human interface device such as a touch screen, and once the customer has made this indication, the point of sale computing device is triggered to transmit, through the application programming interface of the third party remote database, a redemption data message including a redemption data cryptogram indicating the selection of the one or more alternative payment options. When the customer decides to pay by points, effectively the system can conduct a just in time financing payment for the points portion of the payment for settlement.

A challenge with multiple different computing systems working together to process a highly secure data communications flow, such as one for payments, is that the devices cannot trust one another from a cyber security perspective, an additional technical safeguards need to be implemented in the technical implementation of the specific messaging protocols. Furthermore, these data message exchanges, are limited bye the importance of standardization of hardware, a need for usage with legacy, or low processing power hardware, and various privacy or regulatory constraints in relation to they making available of, or sharing of data. Finally, the data sharing and communications, due to the latencies in network communications, are vulnerable to issues that arise because communications are asynchronous and require processing time. As such, it is important to incorporate technical protection measures that also limit the ability of threat actors to perform attacks where they are maliciously emulating signals or taking advantage of gaps in computational timing to run double spend attacks.

Improved point of sale computing systems, devices, backend servers, methods of operation, and computer program products (e.g., non-transitory computer readable media) are contemplated. The point of sale computing devices can include computer memory, electronic display screens configured for displaying interactive user interfaces, human interface devices (e.g., buttons, touch screens, capacitive inputs), storage media, and computer processors. The point of sale computing devices, in some example embodiments, can be portable computing devices running an operating system, an application environment, with various mobile applications running thereon.

In operation, the point of sale computing devices are able to secure coordinate with the backend third party remote database to first authenticate the identity of the user and that the user has available points for redemption, and then provide an improved option (e.g., for example forking the user experience path) so that the user is able to select a partial or full redemption of the points to satisfy a partial or full payment. The record for the points stored on the backend can be locked or reserved, and this confirmation of locking or reservation can be used in a response message. When the user consummates the payment using either all points or a combination of points and/or money, the point of sale computing device can be configured to generate a settlement record (for later settlement) or otherwise execute a settlement data process in real-time, where a message is sent to the third party remote database to both unlock the points and indicate that they are used, and also to initiate payment to settle the portion of the transaction that was conducted with all points or a combination of points.

In an embodiment, the point of sale computing device is configured to generate a hybrid composite user experience by utilizing user interface style sheets that are returned from the third party remote database that also control one or more visual configurations of the one or more interactive graphical user interface controls. For example, a coordinated user experience is possible where branding consistent user interface elements (e.g., logo.png) or instructions thereof (e.g., font size=11, font=FuturaBold, lineThickness=3 pixels) are provided as part of the data package.

The secure messaging with the application programming interface of the third party remote database can include using a secure cryptographic handshake for authenticating an identity of the user. The secure cryptographic handshake can then be used for reserving in the one or more data records a quantity of payment tokens corresponding to the full payment for a duration of time, and on the third party remote database, these payment tokens may be flagged so that they are locked and cannot be used for a lock-out duration. This locking/reservation process is useful to avoid double spend attacks. In some embodiments, the locking or reservation can be conducted using an encryption key or cryptographic hash such that the corresponding redemption datagram can include a corresponding key or the cryptographic hash to unlock the reservation. In some embodiments, the reservation is configured to be automatically resolved following the passage of a duration of time.

The encryption key or cryptographic hash can be generated based on a data field indicative of a linkage with a third party remote database that includes a cryptographic secret that enables a limited authentication of the identity of the user, and the at least one cryptographic secret is utilized for securing the secure cryptographic handshake, and/or the reservation. The secure cryptographic handshake can includes a confirmation of the reservation tracked in the one or more data records the quantity of payment tokens corresponding to the full payment for the duration of time.

During redemption, the redemption data message can be configured with a cryptographic secret and a data field indicative of an amount of redemption. A backend computer server, upon receiving the redemption data message, processes the redemption data message and releases a reservation. The redemption data message can then trigger generation of a receipt data message that can be displayed on the electronic display.

In variant embodiments, there can be a single or a plurality of mobile applications that reside on and are running on the point of sale computing device.

For example, the point of sale computing device could be a portable handheld device running a first mobile application configured for interfacing with the application programming interface of the third party remote database and a second mobile application configured for processing the payment data message, the first mobile application and the second mobile application virtually segregated from one another. The first mobile application could be a mobile application that is specially configured for conducting part of the interaction channel relating to the possible redemption of reward points and the second mobile application could be specially configured for conducting the payment and settlement. The first and second mobile applications can also coordinate amongst one another using limited application programming interfaces to consummate the final settlement using a combination of points and processed payments.

In the two mobile application variant, two secure mobile applications can be configured for limited intercommunications based on the pre-exchanged keys such that secure communications can be maintained with a level of logical separation between the two applications, especially if the applications are controlled by different entities. For example, the first mobile application may control a secure communications to the financial institution backend, and the second mobile application should be unable to directly interrogate the first mobile application for information absent a customer interaction (e.g., so it cannot obtain point balances without authorization). In another embodiment, the secure communications are further limited such that the first mobile application conducts various functionality but the communications to the second mobile application are limited to simple binary responses of TRUE or FALSE to avoid information leakage. For example, when a payment is being processed indicative of a partial payment, the second mobile application can query whether the user identifier is associated with the point system to determine whether user interface elements corresponding to the points redemption should be surfaced. The second mobile application can then send a limited query asking whether there are sufficient points reserved on the customer's account, and upon receiving a positive confirmation, the payment can be processed using the specified combination of points and cash/credit payment. The second mobile application can send a demand message indicating the redemption request and settlement through an alternate mechanism to settle up the amount of payment conducted with points. The first mobile application can receive this demand message, process the payment using part or all of the reserved points through the backend application programming interface to the third party remote server. The third party remote server can then unlock the reservation of points, identify them as burned/redeemed, provide a confirmation to the first mobile application, and then the first mobile application can then be triggered to respond affirmatively (e.g., 200 OK) to the first mobile application.

A benefit of the computing approaches provided herein is that an improved computational framework is set up to securely handle data communications and provide remote redemption capabilities at a single point of sale terminal computing device such that there is no change in customer payment behavior. The improved technical capabilities can be adapted such that an upgrade in firmware or software can be loaded onto the point of sale device terminals (e.g., pushed out as a periodic update) so that there is low or no lift for merchant integration, reducing the reliance on merchant employees who may not be comfortable with implementing advanced functionality. The improved secure messages are adapted to improve a level of security and fraud prevention, and technical partnerships can be set up for automatic communications with payment processor entities and rewards program processor entities such that secure communication pathways are set up between remote computing platforms that require a level of virtual and cyber security segregation from one another.

Corresponding methods, computer program programs are contemplated. The computer program products can be physically affixed in the form of articles of manufacture, such as non-transitory computer readable media stored thereon having machine interpretable instructions that are executable by a computer processor. Upon execution by the computer processor, the processor performs steps of a method for data process integration as described in various embodiments herein.

The processes described herein do not necessarily need to relate to payments or redemption/burning of points. In particular, a messaging framework is described where once a user provides an initial first provisioning of information (e.g., through a tap or other data communication), the user can be identified at a third party database and communications can automatically be set up so that a priori services can be conducted in a posteriori manner. To provide these types of additional services, additional set up of encrypted communications corridors are established by way of the framework to allow for increased functionality without requiring a second verification or identification step explicitly being taken by the user.

Similarly, the processes can be used, instead of in addition to points redemption, for extended functionality, such as chained service provisioning, where a third party device can be unlocked or otherwise made accessible. An example of a chained service provisioning may be the usage at a point of sale terminal during payment to also unlock various other devices, such as unlocking a propane filling station controlled by a third party server so that a user is now able to head over after purchase to go and fill up a propane tank.

The chained services provisioning means that not only payments can be conducted using points, but extended functionality can also include, either in addition to or instead of points redemption, sending of receipts, unlocking of devices, among others, through a sequence of electronic steps that could automatically happen that are dependent on the previous step where a workflow is initiated. As a practical example, a customer would be able to use the system to pay for propane in store, which electronically triggers an attendant to start filling instead of the attendant waiting for a person to produce a receipt in person.

In some embodiments, the point of sale/payment terminal includes two separate on-board mobile applications that are in electronic communication with one another. A payment processing application that is configured for secure communications for payment processing operates in concert with companion mobile application on the point of sale/payment terminal. The companion mobile application can be side loaded or otherwise running on a same instance as the point of sale/payment terminal, such that both applications are accessible by an operating system of the point of sale/payment terminal.

The companion mobile application is configured for establishing electronic communications with an issuer backend computing server, and in some embodiments, can establish at least two communication channels, a high security channel using increased encryption and security for initial retrieval of a secondary identifier (e.g., transmission of secure information to obtain a loyalty membership number and/or a related initial datagram including loyalty information), and a lower security channel for operations using the secondary identifier (e.g., loyalty points redemption, querying whether the user is eligible for enhanced promotions, determining what type of options to display).

The companion mobile application can be used to control and inject screens and interactive display objects during the graphical user interface flow provided by the point of sale/payment terminal based on the information returned on the lower security channel, the interactive display objects being interactable to select a redemption option. In some embodiments, the companion mobile application is configured to modify the selection of what options to show to the user, and the injection of graphical user interface elements and the specific formatting can be set in alignment with a style sheet data object residing on storage on the point of sale/payment terminal. The high security can be conducted using a institution public key for increased encryption and security. This can be used for transmitting an encrypted PAN (for physical transactions) or DPAN (for digital wallet transactions) by the companion mobile application.

In some embodiments, the redemption is used to offset the transaction to reduce the total amount payable in a spawned payment transaction, alongside a spawned redemption transaction. In some embodiments, the spawned payment transaction is for the full original amount, and the spawned redemption transaction is used to process a reimbursement. The companion mobile application can be configured for controlling asynchronous processing of the spawned payment transaction and the spawned redemption transaction, storing the spawned redemption transaction messages in a buffer that is flushed periodically with other the spawned redemption transactions, reducing overall communication overhead. In some embodiments, the buffer flush timing is based on a period of reduced communications load across the lower security channel.

### DESCRIPTION OF THE FIGURES

In the figures, embodiments are illustrated by way of example. It is to be expressly understood that the description and figures are only for the purpose of illustration and as an aid to understanding.

Embodiments will now be described, by way of example only, with reference to the attached figures, wherein in the figures:

FIG. 1 is a block schematic diagram of an example system for conducting improved point of sale computing by integrating payment data processes with third party computer servers, according to some embodiments.

FIG. 2 is a system diagram showing a block schematic illustrating a computing system that includes a point of sale computing device interoperating with a user interface and a backend processor, according to some embodiments.

FIG. 3 is a flowchart diagram of a computer method for data process integration using a single integrated application, according to some embodiments.

FIG. 4 is a flowchart diagram of a computer method for data process integration using two segregated mobile applications, according to some embodiments.

FIG. 5 is a set of screen renderings showing an example user experience at the point of sale computing device when redeeming reward points in association with a purchase, according to some embodiments.

FIG. 6 is a set of screen renderings showing an example user experience at the point of sale computing device when redeeming reward points in association with a chosen portion of the purchase, according to some embodiments.

FIGS. 7A, 7B, 7C, 7D, 7E, 7F are example user interface renderings showing different segments of a non-limiting exemplar data message exchange process for conducting an electronic payment in accordance with some embodiments described herein.

FIG. 8 is a computer diagram showing an example computing device, according to some embodiments.

FIG. 9 is a computer diagram showing an example special purpose machine, according to some embodiments.

FIG. 10 is a computer architecture diagram showing interconnected computer systems and intersystem data message flows, according to some embodiments.

FIG. 11A is a computer architecture diagram showing a companion mobile application operating alongside a point of sale/payment terminal mobile application on the point of sale/payment terminal device, according to some embodiments. FIG. 11B is a continuation of the computer architecture diagram showing a companion mobile application operating alongside a point of sale/payment terminal mobile application on the point of sale/payment terminal device. FIG. 11A and FIG. 11B are meant to be read together as a single diagram.

FIG. 12A is a process diagram showing example steps of a method for interprocess communications, according to some embodiments. FIG. 12B is a continuation of the process diagram showing example steps of a method for interprocess communications, according to some embodiments. FIG. 12C is a continuation of the process diagram showing example steps of a method for interprocess communications, according to some embodiments. FIG. 12A, FIG. 12B, FIG. 12C are meant to be read together as a single diagram.

FIG. 13 is an example user interface showing a number of different rendered UI elements, according to some embodiments.

### DETAILED DESCRIPTION

An improved approach is proposed for data process integration using point of sale/payment terminal computing devices where the point of sale/payment terminal devices are adapted to interoperate with third party remote servers hosting third party remote databases through application programming interfaces exposed as between the point of sale/payment terminal devices and access to the third party remote servers.

Point of sale/payment terminals are computing devices have technical limitations that are imposed by their operating environment or the available hardware, software, and network capabilities of the point of sale/payment terminal device. There are additional limitations that are imposed from a cybersecurity standard, such as those required in relation to certain types of sensitive information, such as payment information.

A companion mobile application operating on the point of sale/payment terminals is proposed for interoperation with an issuer backend computing system, the companion mobile application being callable by the point of sale/payment terminal to inject code or data objects as part of the user interface rendering flow and corresponding data message flow by the point of sale/payment terminal.

Accordingly, when the companion mobile application is called, for example, through a data message including details of a potential payment and a first encrypted sensitive identifier, the companion mobile application is configured to send an encrypted data message with the encrypted sensitive identifier or a variation thereof as a data payload to obtain a second identifier that is a less sensitive field. The second identifier, for example, could be a loyalty account number, whereas the first encrypted sensitive identifier could be a credit card number or other sensitive identifier that can be used as part of a payment authorization process.

The data message to send the first encrypted sensitive identifier, in some embodiments, is conducted across a higher security communication channel than subsequent communications due to the sensitivity of the information being transmitted. For returning the second identifier and subsequent communications, a reduced security level channel can be instantiated for usage. By using different security levels and a plurality of communication channels, the overall system and processing latency can be reduced, while also limiting the overall cybersecurity threat surface.

When the second identifier is obtained, the companion mobile application is configured to interact with the issuer backend computing system to determine whether additional prompts and user interface options are triggered, for example, based on award redemption conditions being met, user preferences, or other internal system logic. The additional prompts and user interface options are provided in the form of interface option data objects from the issuer backend computing system to the companion mobile application, which is configured to transform the interface option data objects into user interface screen rendering instructions to the point of sale/payment terminal device. In some embodiments, the interface option data objects are transformed into rendering code for consistency with a set of user interface style sheet parameters designated by the point of sale/payment terminal device.

In a variant embodiment, the companion mobile application can also be configured to automatically determine the subset of options to be provided as the interface option data objects. The issuer backend computing system may provide eligibility information and total redemption options available, and the companion mobile application may convert these into quantized ranges or a subset of options based on rendering logic stored thereon in memory allocated for the companion mobile application. For example, the companion mobile application may control the rendering of 2-3 redemption options in the form of interactive/interfaceable buttons.

In another variant described herein, the eligibility information may be combined with characteristics identified by the companion mobile application before generating the subset of available options, such that a triggering requirement may require a combination of triggering characteristics from the issuer backend computing system and the companion mobile application or the point of sale/payment terminal device. In a further variant embodiment, the issuer backend computing system is configured to interoperate with a confidential computing backend for determining whether a particular user identifier is located on a confidential computing generated audience list for a particular offer or promotion. These offers or promotions can be returned as part of a data message payload from the issuer backend computing system.

Following the selection of a redemption option of the plurality of redemption options presented by the user interface, the selection identified through processed user inputs, child transaction messages are spawned to the issuer backend computing system, a first child transaction message conducting the payment transaction for the value of the object or service being purchased in accordance with payment rails of the point of sale/payment terminal device using the first identifier to be sent over the higher security communication channel, and a second child transaction message using the second identifier corresponding to the redemption option to be sent over the lower security communication channel.

In some embodiments, the timing of the first child transaction message and the second child transaction message can be controlled by the companion mobile application such that the first child transaction message and the second child transaction message are conducted asynchronously. For example, the first child transaction message can be triggered to be sent as soon as possible on a high priority channel, while the second child transaction message can be sent shortly during a period of availability (e.g., as measured by network performance) on a lower priority channel. In a further variation, the second child transaction message can be bundled with other second child transaction message for sending across a bundled data object for periodic clearance and settlement to reduce the overall network communications overhead requirements.

As described herein, the approach provides a cybersecurity enhanced data message flow that is adapted to use two separate communication channels having different cryptographic security levels to improve overall latency impacts of the data messages. Reducing system latency aids in smoothing a user experience, especially as latency effects compound in highly scaled environments where a large number of point of sale/payment terminal devices are conducting a large number of temporally proximate or simultaneous transactions for a large number of users. This type of highly scaled environment can include high throughput/low margin businesses, such as grocery shopping, among others, where latency effects can slow down the speed at which user purchases can be processed by cashiers.

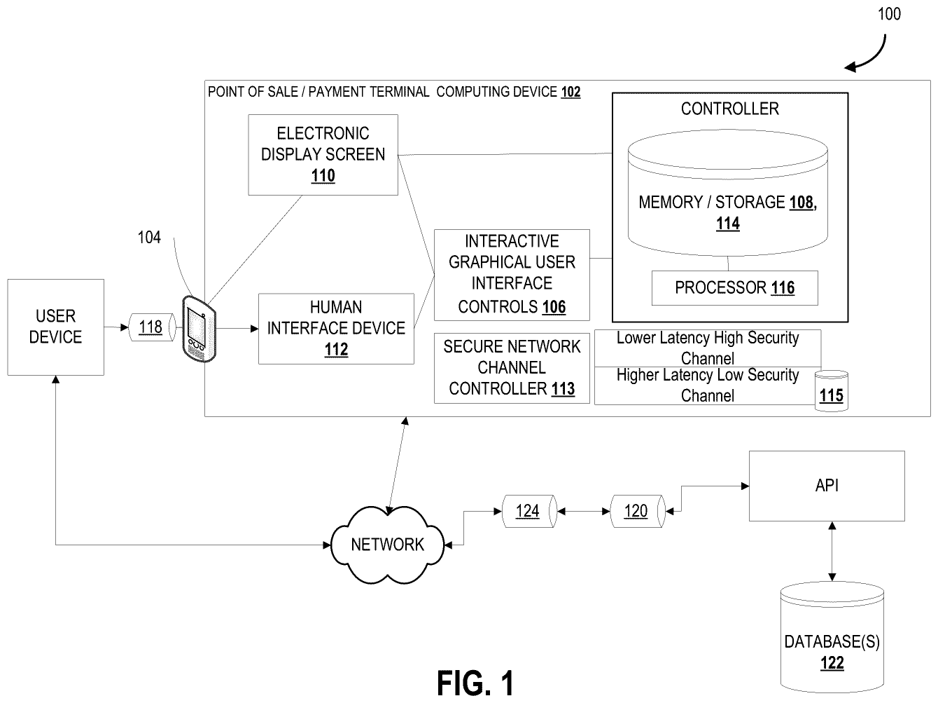

FIG. 1 is a block schematic diagram of an example system for conducting improved point of sale/payment terminal computing by integrating payment data processes with third party computer servers, according to some embodiments.

In the system 100, the point of sale/payment terminal computing device 102 can be a portable handheld device such as a payment terminal. The point of sale/payment terminal computing device 102 can be operated by a merchant employee, or alternatively, can be operated as part of a “self check-out” routine in which no merchant employee is present. The point of sale/payment terminal computing device 102 can also operate in a situation where the point of sale/payment terminal computing device 102 interoperates with another computing system (e.g., inventory management system, self-check out coordination device) that provides it with data structures representing a transaction to be processed. For example, the point of sale/payment terminal computing device 102 can have physical buttons thereon where the merchant employee inputs a dollar amount of a transaction. When depressed, the buttons operate as a human interface device, such as buttons on a membrane keyboard. Similarly, physical buttons can be replaced or be provided alongside touch interfaces, which can use a physical capacitive touch sensor disposed behind the screen to capture finger touches through detecting positions of electrical characteristic changes.

An interactive user interface 104 is rendered on the point of sale/payment terminal computing device 102, through an electronic display screen 110, to provide the user with information and queries relating to the status of the transaction. The information and queries may include the purchase price, the method of payment, whether the transaction is pending, when the transaction is complete, and how the user would like to receive their receipt.

The interactive user interface 104 is controlled by a graphics controller operating in concert with a processor, which renders and tracks human interface inputs associated with the interactive graphical user interface controls 106 to allow the user to utilize their alternative payment options at the point of sale/payment terminal computing device 102. These alternative payment options can include the coupling to a third party server that handles payment through a redemption of points (partial or full), or alternate payment through promotions, etc.

Because the alternative payment options are conducted through a third party interface/backend computing systems, improved data messaging approaches are required in respect of reducing cyber security vulnerabilities as well as improving overall communications efficiency at scale.

The interactive user interface 104 may pose queries to the user which require the user to select an input through the human interface device 114. The human interface device 114 can be a touch screen, or alternatively can be push buttons, which provide an input to the interactive graphical user interface controls 106 through capacitive coupling.

The point of sale/payment terminal computing device 102 contains a computer memory 108, a non-transitory computer readable storage media 114, and a processor 116. The computer memory 108 and non-transitory computer readable storage media 114 allow updates to the firmware and software to be loaded onto the point of sale/payment terminal computing device 102 so that there is minimal lift for merchant integration. For example, periodic updates can be rolled out for the point of sale/payment terminal computing device 102 without the need for the merchant to understand the implementation of advanced functionality.

In some embodiments, the point of sale/payment terminal computing device 102 store two separate mobile applications on memory storage 108, 114, a first mobile application and a second mobile application. In this two mobile application variant, two secure mobile applications can be configured for limited intercommunications based on the pre-exchanged keys such that secure communications can be maintained with a level of logical separation between the two applications, especially if the applications are controlled by different entities. The first mobile application is a high security payment processing application that is configured for secure communications for payment processing operates in concert with the second mobile application, a companion mobile application on the point of sale/payment terminal. The companion mobile application can be side loaded or otherwise running on a same instance as the point of sale/payment terminal, such that both applications are accessible by an operating system of the point of sale/payment terminal. The first mobile application is already authenticated and is a trusted application having trusted access. The trusted access can be conducted based on a MAC value that is created with a pre-injected TDES key by the device and validated by the backend, for example. The companion mobile application is used to reside alongside the first mobile application on the trusted device, for example, using the same trusted networking interfaces and identifiers, and the companion mobile application can be a signed mobile application for increased security.

Memory storage 108, 114 can include a special memory region that has enhanced security or limited accessibility storing exchanged keys for usage with third party remote database servers.

For example, the first mobile application may control a secure communications to the financial institution backend, and the second mobile application should be unable to directly interrogate the first mobile application for information absent a customer interaction (e.g., so it cannot obtain point balances without authorization). The first mobile application may have special access to the specific keys stored on memory storage 108, 114 to support the extended functionality interaction, and in some embodiments, the second mobile application does not have any access to these keys. For example, the secure communications can be further limited such that the first mobile application conducts various functionality but the communications to the second mobile application are limited to simple binary responses of TRUE or FALSE to avoid information leakage.

For example, when a payment is being processed indicative of a partial payment, the second mobile application can control the first mobile application to initiate a query by sending a query message to the backend application programming interface to determine whether the user identifier is associated with the point system to determine whether user interface elements corresponding to the points redemption should be surfaced.

The second mobile application can then send a limited query data message to the first mobile application asking whether there are sufficient points reserved on the customer's account, and upon receiving a positive confirmation, the payment can be processed using the specified combination of points and cash/credit payment.

The second mobile application can send a demand message indicating the redemption request and settlement through an alternate mechanism to settle up the amount of payment conducted with points.

The first mobile application can receive this demand message, process the payment using part or all of the reserved points through the backend application programming interface to the third party remote server. The third party remote server can then unlock the reservation of points, identify them as burned/redeemed, provide a confirmation to the first mobile application, and then the first mobile application can then be triggered to respond affirmatively (e.g., 200 OK) to the second mobile application.

A customer user begins the transaction by sending a payment data message 118 to the point of sale/payment terminal computing device 102 in the form of a digital account identifier. The digital account identifier can be unique to the user and could be created as a result of the user opening a credit account with a bank. The payment data message 118 can be sent through a mobile device or banking card using near field communication. Alternatively, the payment data message 118 can be transferred to the point of sale/payment terminal computing device 102 by inserting a banking card into a slot located on the point of sale/payment terminal computing device 102. The payment data message 118 contains an encrypted data structure which has been tokenized to become a payment data cryptogram 120. In one embodiment, tokenization can occur through random number generation. The tokenized portion of the payment data structure includes a data field which is linked to a third party remote database 122 containing the users banking information.

The payment data message 118 can also include a field indicative that the customer user has enrolled in a particular points or loyalty program, and in some embodiments, this field includes an identifier that can be used as a unique primary key for running a query on a third party backend interface to the third party database 112 for conducting various queries and interactions. These queries can include whether the customer corresponding to the primary key is enrolled, whether the customer has sufficient points on the corresponding account, whether a sufficient allotment of points has been reserved (e.g., to avoid double spend). A benefit of having such a payment data message 118 being sent along during the point of the customer's first interaction with point of sale/payment terminal computing device 102 is that loyalty program rewards can be conducted based on a “single tap” type approach where the customer is not required to make a second provisioning of information relating to the loyalty information or points on third party database 122. Rather, the computational backend securely communicates this information on first tap such that the user interface is immediately able to offer points redemption at the first step.

The third party database 122 would have access to or store information including the user's available credit, potential alternative payment options, and potential promotions that could be used for the specific purchase. In some embodiments, alternative payment options can include a rewards program in which a bank or credit union provides a user with points which can be redeemed for liquid currency as a reward for using their credit account. A challenge with point of sale/payment terminal payments using rewards is that the third party database 122 is outside of the cyber security and technology ecosystem of the point of sale/payment terminal device 102, and additional steps can be helpful to both coordinate the user experience through the transmission of user interface commands, and to create secure pathways for communications both to avoid malicious third parties from accessing the communications, but also to help with avoiding potential issues that could arise from processing delays, such as double spend attacks.

The third party database 122 and the point of sale/payment terminal computing device 102 can be pre-configured during a separate set-up process (e.g., triggered when the merchant logs into a point of sale/payment terminal computing device 102 configuration portal to set up an initial key exchange to generate and/or store keypairs (e.g., symmetrical, public/private key pairs) on the memory/storage 108, 114. In another variant described herein, the initial key exchange keys can be limited to a specific special/limited-purpose mobile application and stored on a segregated memory space or otherwise not made available to the point of sale/payment terminal computing device 102 for enhanced security and computational segregation.

The processor 116 is connected either directly (WiFi or Bluetooth) or indirectly (using an ad-hoc connection) to an application programming interface of the third party remote database 122. The processor 116 authenticates the identity of the user by communicating the payment data message 118 to the application programming interface of the third party remote database 122 which provides a response to the processor 116 that the user has an account associated with the tokenized portion of the payment data structure 118. Once it has been confirmed that the user has an account enrolled with the third party database 122, the third party database 122 will assess whether the user has any available alternative payment options or promotions that would apply to the purchase. A determination that the user has an available alternative payment option could include a positive points balance associated with the account which could be determined, for example, by interrogating a data record.

In one embodiment, if the third party remote database 122 validates that the user has an alternative payment method available to them, then the processor 116 will render a prompt for the user through the electronic display screen 110, using the graphical user interface controls 106, to choose whether to complete the purchase using the alternative payment option. If the user wishes to complete the transaction using an alternative payment option, then the user will be able to select that option using the human interface device 114. For example, the user could select to pay by points.

The point of sale/payment terminal computing device 102 can then render, on a electronic display screen 110, the interactive graphical user interface controls 106 corresponding to the one or more alternative payment options and provide a prompt for a user to complete the payment using the one or more alternative payment options. To keep the user interface and experience consistent, in some embodiments, as part of the verification process, the return data message from the third party remote database 122 includes style set information or other branding or graphical items in the response payload.

In another embodiment, the user can select to complete only a portion of the transaction using the alternative payment option. The remainder of the transaction will be completed using a standard method of payment such as a credit card, debit card or cash.

By providing the user with the option to use alternative payment methods at the point of sale/payment terminal, the alternative payment method gains value for the user as they can be redeemed with ease.

If the user has selected to use an alternative payment method for the transaction, the processor 116 transmits a redemption data message 124 to the application programming interface of the third party remote database 122. The redemption data message 124 contains data that has been made secure using cryptography which provides instructions to the third party remote database 122 that the user has selected an alternative payment option to complete the payment. The method of cryptography used for the data package selecting the alternative payment option can include symmetric key or hash functions. In some embodiments, lightweight message encryption approaches are used to avoid issues with scalability and computational resource usage, especially where there are potentially a large number of concurrent transactions or it is important that the system remains responsive.

A secure network channel controller 113 is configured for coupling with communication protocols and interfaces of the device 102. The second mobile application is configured can establish at least two communication channels, a high security channel using increased encryption and security for initial retrieval of a secondary identifier (e.g., transmission of secure information to obtain a loyalty membership number and/or a related initial datagram including loyalty information), and a lower security channel for operations using the secondary identifier (e.g., loyalty points redemption, querying whether the user is eligible for enhanced promotions, determining what type of options to display). The secure network channel controller 113 establishes different security levels.

While an optimal solution would have high security for every communication, when operating at scale, the full security level may create undesirable latency effects that may unnecessarily slow down a payment flow, which may be a major issue for premises that need to process a large throughput of transactions (e.g., a grocery store). The high security channel is encrypted using a combination of an institution public key and the secure channel key stored on the device 102 that is used as part of the trusted ecosystem. Accordingly, communications across the high security channel have a higher encryption overhead and computing time cost, and communications and data messages to be sent over the high security channel are thus limited to the bare minimum of fields required for payment transaction information. In the examples described herein, the high security channel can also be utilized by a companion mobile application to obtain a secondary identifier, the loyalty identifier field, for example, and once the secondary identifier is obtained, the lower security channel (e.g., encrypted or signed only with the institution key) can be instantiated for communications with reduced encryption overhead.

The secure network channel controller 113 is configured to control which data messages are sent over which channel. As high security communications can be expensive from a computational perspective, in some embodiments, the device 102 only utilizes the high security channel for transmission of more sensitive payment information, and for communications by the second mobile application (e.g., the companion mobile application) relating to loyalty information and available promotions, offers, and available points/redemptions used to control and inject screens and interactive display objects, these communications can be conducted on the lower security channel to reserve the high security channel for priority and sensitive communications. This lower security channel is used for the communication flows and data message communications relating to the presentment of the display items for redemption, and the corresponding redemption processes, if selected.

When the user interacts with the interactive display objects to select a redemption option, for example, by pressing a button or otherwise indicating the selection, the payment process graphical user interface journey can conclude (from the user's perspective), and multiple transaction messages can be spawned for transmission based on routing/buffering instructions stored on the secure network channel controller 113. A set of routing tables and buffering instructions can be used to reduce overall messaging and bandwidth overhead by using asynchronous processing of the spawned payment transaction and the spawned redemption transaction, storing the spawned redemption transaction messages in a buffer 115 that is flushed periodically with other the spawned redemption transactions, reducing overall communication overhead. In some embodiments, the buffer flush timing is based on a period of reduced communications load across the lower security channel. The buffer flush timing, for example, can be conducted every 15 minutes, sending a package of redemption messages.

Where there is asynchronous processing, in some embodiments, the issuer backend, upon generating redemption options for a particular user, may lock a number of points on the backend to ensure that the there are sufficient points for the redemption message to be processed. After the buffer flush time or a timeout period, in some embodiments, the issuer backend may be configured to unlock the points for future usage.

In some embodiments, the buffer 115's flush period and the issuer backend points locking mechanism on the records database can be coupled or matched such that the maximum redeemable points option shown are locked for a minimum period, while also being able to batch process asynchronous messages.

For example, in a highly scaled environment, there may be 100 point of sale device/payment terminals at a large wholescale club store. These devices can coordinate to utilize communication resources assigned to the low security channel, for example, timing asynchronous communications across an assigned time bucket during lower communication volume time periods, grouping every transaction for a period of 15 minutes together (e.g., 15 redemption requests) to batch process redemptions at the backend in grouped data messages to reduce overall messaging overhead. In this scaled example, the messages only incur a single message cost overhead. However, the asynchronous processing requires coordinated locking to avoid overspend.

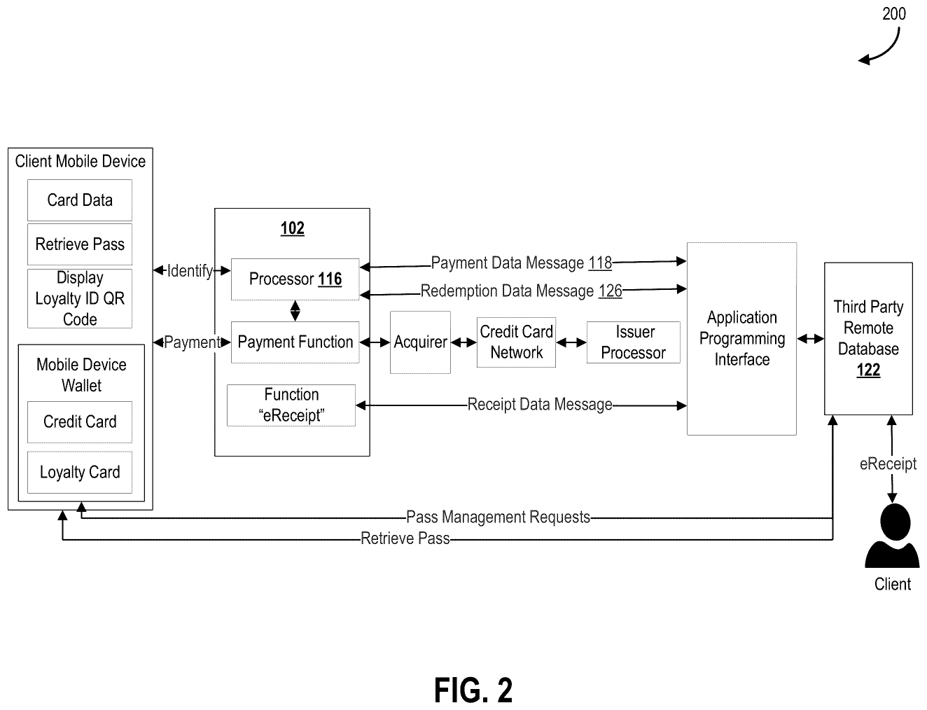

FIG. 2 is a system diagram showing a block schematic illustrating a computing system that includes a point of sale/payment terminal computing device interoperating with a user interface and a backend processor, according to some embodiments.

In the system 200, the point of sale/payment terminal computing device 102 communicates with the third party remote database 122 through an application programming interface. When the processor 116 of the point of sale/payment terminal computing device 102 sends a data message to validate the users identity within the third party remote database 122, the processor uses a cryptographic handshake to establish a secure connection with the application programming interface of the third party remote database 122.

Once the secure connection has been established through the cryptographic handshake, the processor 116 and third party remote database 122 will share a cryptographic secret which will enable the processor 116 and third party remote database 122 to decrypt any secure messages communicated between the devices.

After the user has selected to complete the purchase with an alternative method of payment, the processor 116 can use the cryptographic handshake to reserve the quantity of reward points which the user has selected to use in the particular transaction. To ensure that the transaction does not occur prior to the reward points being reserved, the third party remote database can send a secure message, using the cryptographic handshake, to the processor 116 confirming that the selected quantity of reward points has been reserved for the particular transaction.

In one embodiment, the third party remote database will reserve the selected portion of reward points for a pre-determined amount of time corresponding to the expected time to complete the transaction.

The usage of a reservation system provides protection from the threat of fraudulent transactions such as a double spend attack. The third party database 122 will ensure that while the customer is completing the transaction, no other processor can access the reserved payment tokens through a simultaneously communicated payment data message 118. This provides a computational lock mechanism to avoid a situation where a malicious customer uses simultaneous spend transactions against a same balance to take advantage of communications latencies in updating the third party database 112 with transactions to be conducted.

Once the user has selected the portion of reward points that they wish to use on the transaction, and have confirmed that they wish to complete the transaction, the processor 116 may send a redemption data message 124 to the application programming interface of the third party remote database 122. Since the redemption data message 124 contains the cryptographic secret, the third party remote database 122 will be able to decrypt the data field included in the redemption data message 124 which contains the command to release the quantity of reward points reserved for the particular transaction.

In another embodiment, a receipt data message will be communicated by the third party database 122 to the processor 116. The receipt data message is communicated after the third party database 122 receives a redemption data message 124 and releases the reserved reward points from the user's account. The receipt data message is sent to the processor 116 and triggers the point of sale/payment terminal computing device 102 to render, using the interactive graphical user interface controls 106, a message on the electronic display screen 110 to the user that a receipt has been generated. The point of sale/payment terminal computing device 102 may provide a query to the user asking whether they would like to have their receipt printed or sent via email. The user will then be given the option to select either option through the human interface device 114.

In another embodiment, the user can receive a notification on their mobile device that the transaction has been completed which is saved within the payment application used for the transaction.

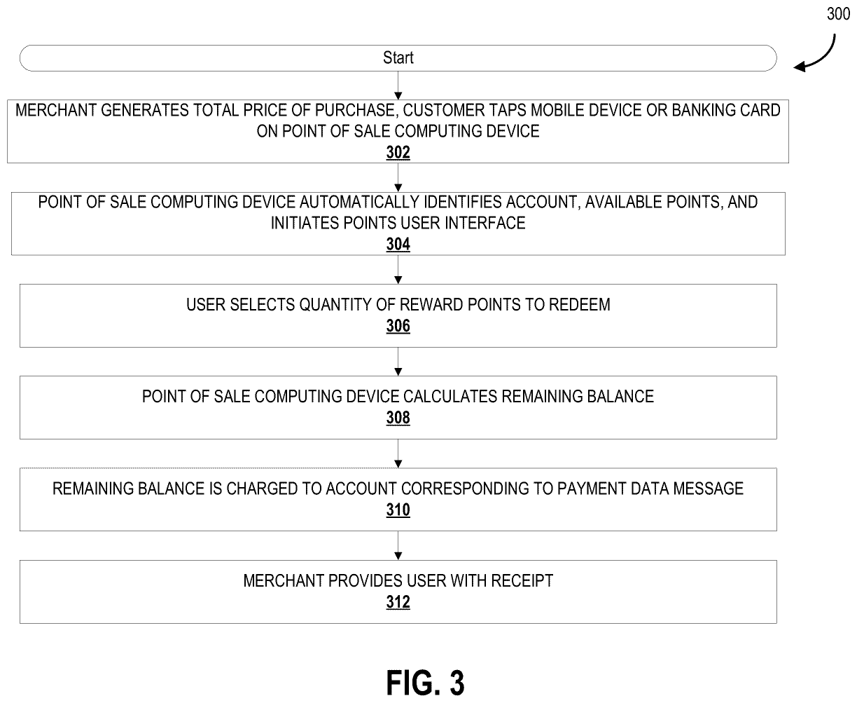

FIG. 3 is a flowchart diagram of a computer method for data process integration using a single integrated application, according to some embodiments.

In FIG. 3, the point of sale/payment terminal computing device 102 is running an single application which can coordinate a combination of payments through alternative payment methods and standard payment methods (i.e. credit or debit).

The transaction begins with Step 1 302, in which the merchant provides the user with a purchase price and the customer starts the payment process by tapping or inserting a payment card to transfer an initial payment data message.

The system at Step 2 304 automatically identifies the customer as a member of a program and determines that the customer has available points for redemption. So long as the processor 116 has confirmed that the user's payment data message 118 corresponds to a valid account within the third party remote database 122, the electronic display screen 110 of the point of sale/payment terminal computing device 102 will then display an option to select the quantity of points which the user wishes to use for this transaction. If the user wishes to complete the entire transaction using an alternative payment method, then the transaction will be completed after the processor 116 transmits a redemption data message 124 and receives a receipt data message in response from the third party remote database 122. In another embodiment, the user may wish to complete only a portion of the transaction using an alternative payment option.

The user will then select, at Step 3 306 a specified quantity of reward points to redeem for this transaction, and the preliminary portion of the transaction will be completed after the processor 116 transmits a redemption data message 124 and receives a receipt data message in return from the third party remote database 122. The point of sale/payment terminal computing device 102 will then calculate the remaining balance at Step 4 308.

The remaining balance is then paid at Step 5 310. At Step 5 310, the processor 116 will automatically send a secure message to the third party remote database 122 to settle the remaining balance from an account within the third party remote database 122 corresponding to the payment data message provided at Step 1 302.

The transaction is completed at Step 6 312 at which time the merchant provides the user with a copy of their receipt containing information relevant to the transaction such as the items purchased, subtotal, number of reward points used, number of reward points earned, number of reward points remaining, and credit/debit card information.

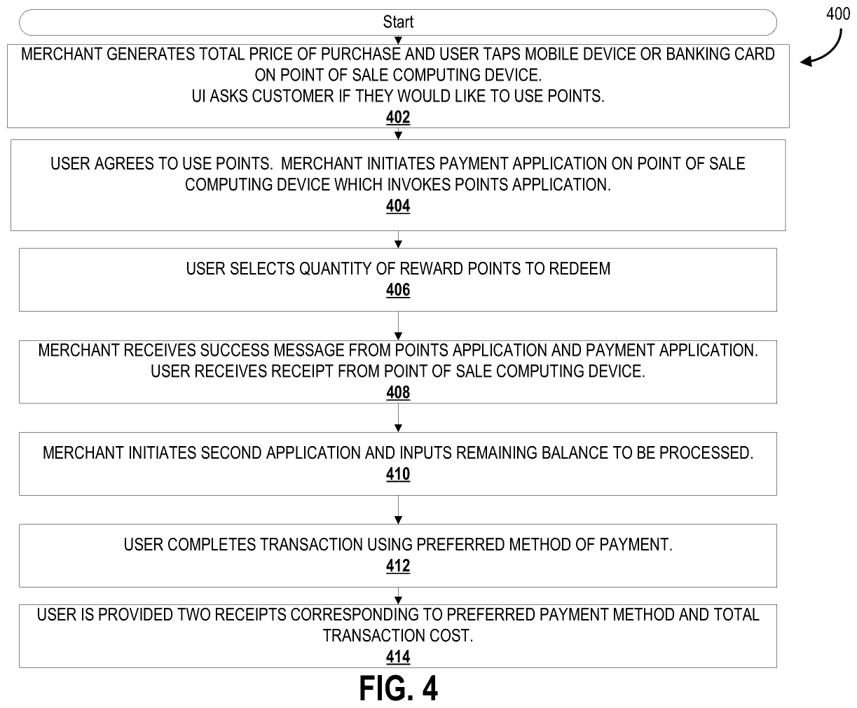

FIG. 4 is a flowchart diagram of a computer method for data process integration using two segregated mobile applications, according to some embodiments.

In another embodiment, the integrated application can consist of two separate applications, one for processing payment using an alternative payment method such as points (e.g., the points application), and another for processing payment using standard payment options. The two applications are integrated so that the point of sale/payment terminal computing device 102 is able to complete a transaction using a combination of reward points and payment methods without requiring any repeated inputs from the user. For example, after using near field communications technology to transmit a payment data message 118 to the processor, the user does not need to perform this same step again as the integrated application will store the payment data message 118 on the computer memory 108 and will automatically re-establish a secure connection with the third party remote database 122 to complete the remainder of the transaction using payment methods available to the user through the account corresponding to the payment data message 118.

In FIG. 4, the point of sale/payment terminal computing device 102 is running two segregated applications in which the first application interfaces with the third party remote database 122 to process payments through the customer's available points. The first points application and a second payment application can run on the point of sale/payment terminal computing device 102 and have special limited intercommunication pathways between one another for enhanced cyber security and privacy. The first points application can operate as a secondary (slave) to have functions that are initiated or invoked by the second payment application operating as a primary driving application (master).

In one embodiment, the first and second application are virtually segregated from one another and do not share information. The segregation of the two applications adds a further protection against fraud and malicious actors. A key ceremony can be conducted during initial enrollment to configure a secure points application that is controlled by a primary payment application.

In some embodiments, the payment data message can invoke both applications to run on the point of sale/payment terminal computing device 102, for example through a triggering configuration of the point of sale/payment terminal computing device 102. For example, a logical trigger can be established where a whitelist of certain payment card BINs automatically trigger both applications to be initiated as these customers are potentially registered under a corresponding points program. For example, holders of a certain credit card may automatically be enrolled in a particular points program and these can be identified through certain BINs (e.g., the first few numbers on the card).

The transaction begins with Step 1 402, in which the merchant provides the user with a purchase price and the user taps his or her mobile device or banking card on the point of sale/payment terminal computing device. The payment application is initiated and begins to run. At Step 2 404, the payment data message 118 is interrogated and the user is found to be a member of the points program and have an amount of available points to be spent.

In a first embodiment, the payment application can automatically control the points application to interrogate the third party remote database 122 using keys accessible to the points application. The terminal can then ask the customer if they would like to use their points program to pay. Optionally, the points application can then receive from the customer their points program card details. In another variation, the points application automatically can identify the user's enrollment and this step is not required.

The point of sale/payment terminal computing device 102 payment application can then control the second application to launch to obtain information from the third party remote database 122 such as number of points, cash value of points, redemption information, etc. The points application can also be configured to provide user interface controls or commands to the payment application to generate a hybrid composite user interface that is seamless to the customer, where interface elements from the third party remote database 122 are surfaced for consistency of user experience.

So long as the processor 116 has confirmed that the user's payment data message 118 corresponds to a valid account within the third party remote database 122, the electronic display screen 110 of the point of sale/payment terminal computing device 102 will then display an option to select the quantity of points which the customer wishes to use for this transaction, and the customer can also select to complete only a portion of the transaction using an alternative payment option, such as redeeming points. The user will then select, at Step 3 406 a specified quantity of reward points to redeem for this transaction, and the preliminary portion of the transaction will be completed after the processor 116 transmits a redemption data message 124 and receives a receipt data message in response from the third party remote database 122. This points redemption can be conducted through the points application which returns success or failure data messages to the points application.

At Step 4 408, when completed, the merchant receives a display message, through the electronic display screen 110, on the point of sale/payment terminal computing device 102 which advises them that the portion of the transaction using an alternative payment method is complete and they can now either print a receipt or have it shared with the user through a mobile device or email. The receipt can include information such as the number of reward points used, number of reward points earned and number of reward points remaining. A first receipt can be generated at this step.

At Step 5 410, the user is given/sent the receipt relating to the alternative payment method.

At Step 6 412, the merchant will exit the first application on the point of sale/payment terminal computing device and will open the second application in order to complete the remainder of the transaction. The merchant will manually input the remaining balance to be processed and will hand the user the point of sale/payment terminal computing device 102.

At Step 7 412, the user will complete the transaction by paying with their preferred payment method (i.e. credit, debit) and then will be provided with two additional receipts corresponding to the preferred payment method and the total transaction.

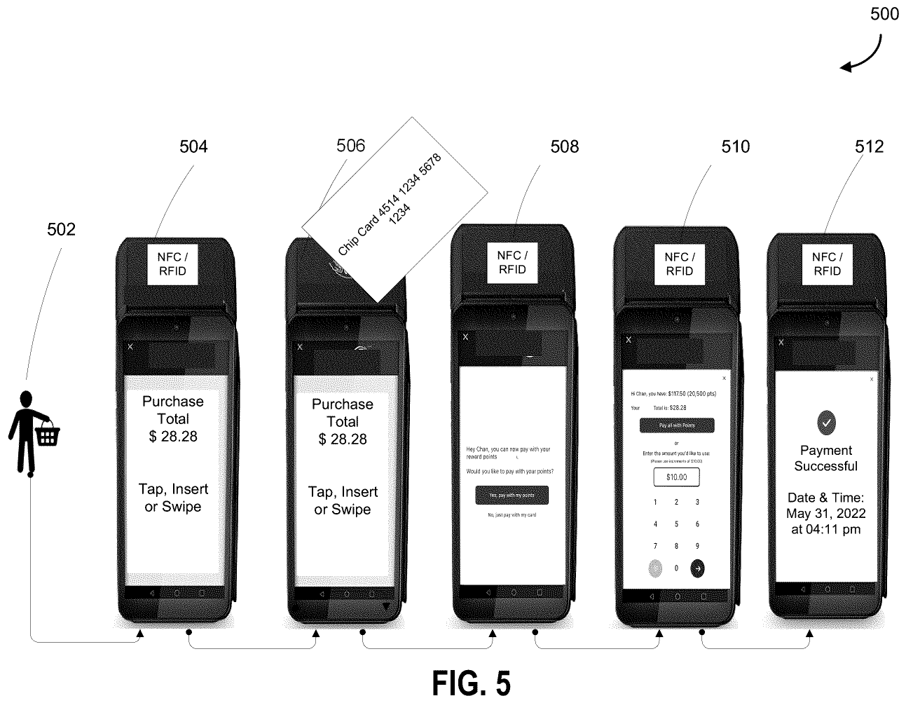

FIG. 5 is a set of screen renderings showing an example user experience at the point of sale/payment terminal computing device when using reward points in association with a purchase, according to some embodiments.

In FIG. 5, the user finishes their shopping 502 and approaches the point of sale/payment terminal computing device 102. At 504, the merchant asks the customer if they would like to pay with an alternative payment method. At 506, the user decides that they would like to use an alternative payment method and “taps” their banking card to the near field communication reader on the point of sale/payment terminal computing device 102. At 508, the user receives a prompt on the electric display screen 110 to select the quantity of reward points they wish to use. The user makes a selection using the human interface device 114. In this example, at 510 the user selects to complete the entire purchase using reward points. At 512, the user is shown a success screen which confirms that the transaction has been completed, alternatively, the success screen can also include a prompt asking the user how they would like to receive their receipt for the transaction (i.e. printed, email, mobile device notification).

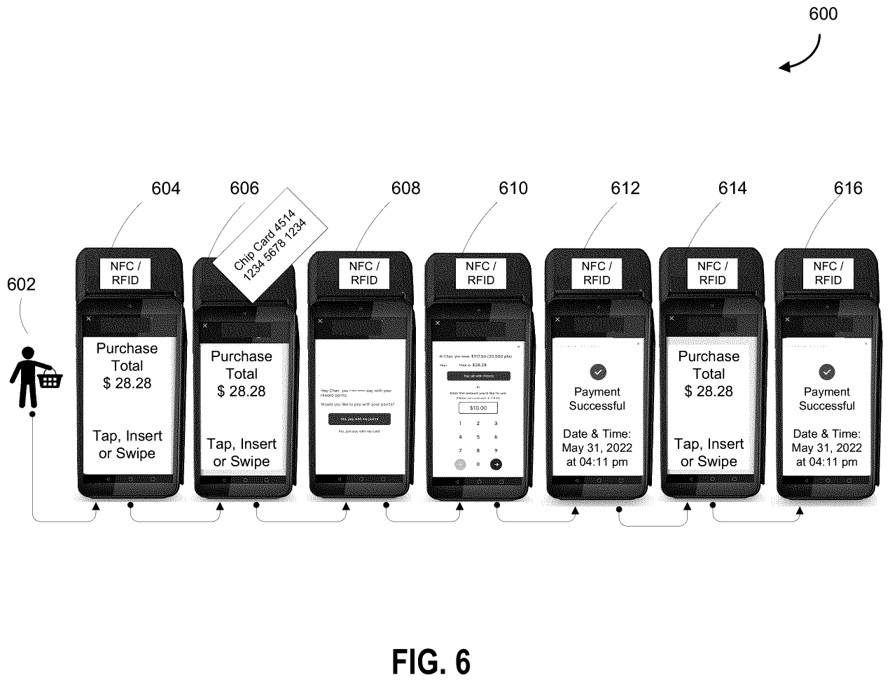

FIG. 6 is a diagram of a user experience at the POS when using reward points to complete only a portion of the entire purchase, according to some embodiments.

In FIG. 6, the user finishes their shopping 602 and approaches the point of sale/payment terminal computing device 102. At 604, the merchant asks the customer if they would like to pay with an alternative payment method. At 606, the user decides that they would like to use an alternative payment method and “taps” their banking card to the near field communication reader on the point of sale/payment terminal computing device 102. At 608, the user receives a prompt on the electric display screen 110 to select the quantity of reward points they wish to use. The user makes a selection using the human interface device 114. In this example, at 610 the user selects to complete a portion of the purchase using reward points. At 612 the user is shown a success screen which confirms that the transaction has been completed, alternatively, the success screen can include a prompt asking the user how they would like to receive their receipt for the alternative payment method portion of the transaction.

At 614, the point of sale/payment terminal computing device 102 will transition from the first application, which was configured to conduct only the portion of the payment using the alternative payment method, to the second application which is configured to complete the payment using a standard method of payment (i.e., debit or credit). Once the second application has initiated, the user will be prompted to complete the payment.

The user may select to complete the purchase using their banking card, as seen in 614, or may use a mobile device, or any other method capable of communicating with the point of sale/payment terminal computing device 102 through near field communication. At 616, after the user has completed the remainder of the purchase, the point of sale/payment terminal computing device 102 will show a success screen on the electronic display screen 110, alternatively, the success screen can also include a prompt asking the user how they would like to receive their receipt for the transaction (i.e. printed, email, mobile device notification). The user will be provided at 616 with two receipts, one for the overall transaction and a second for the standard method of payment.

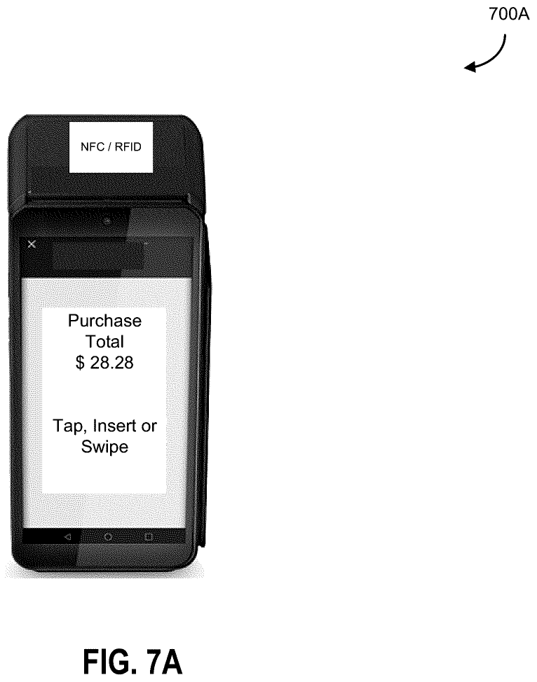

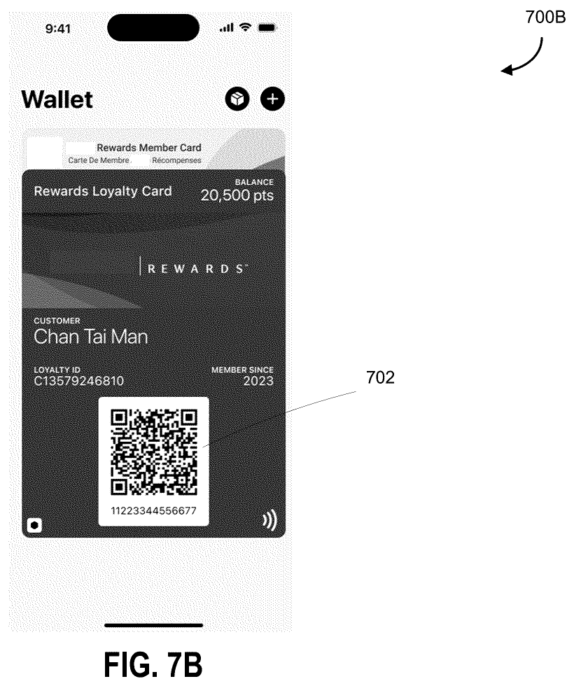

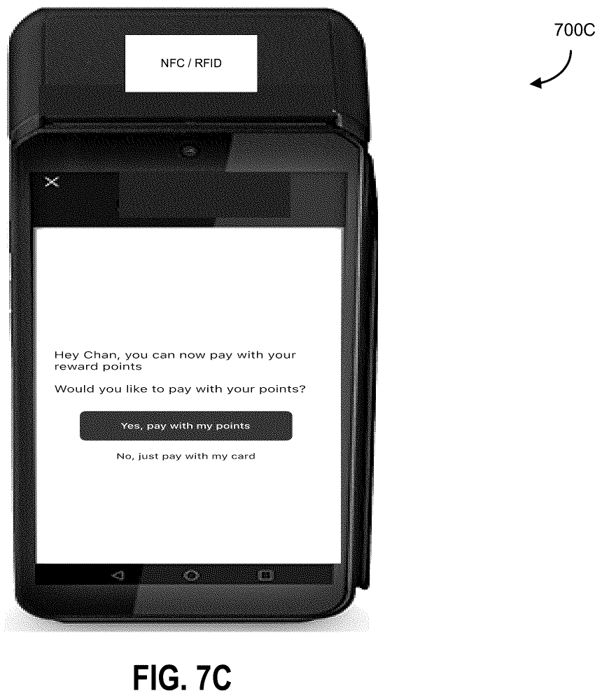

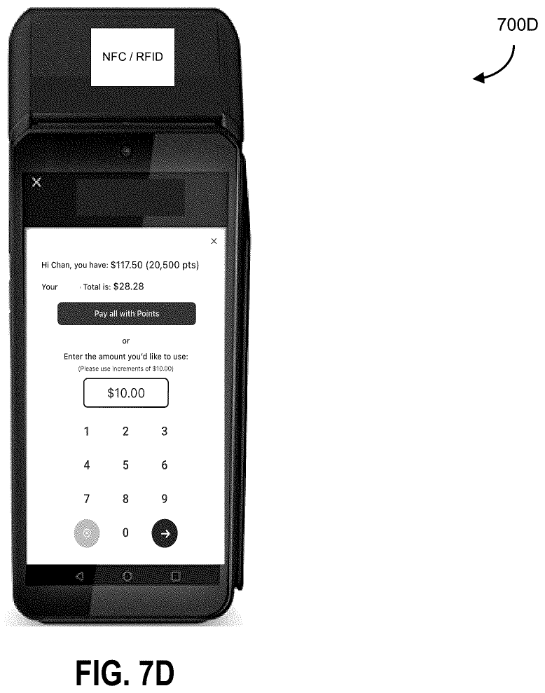

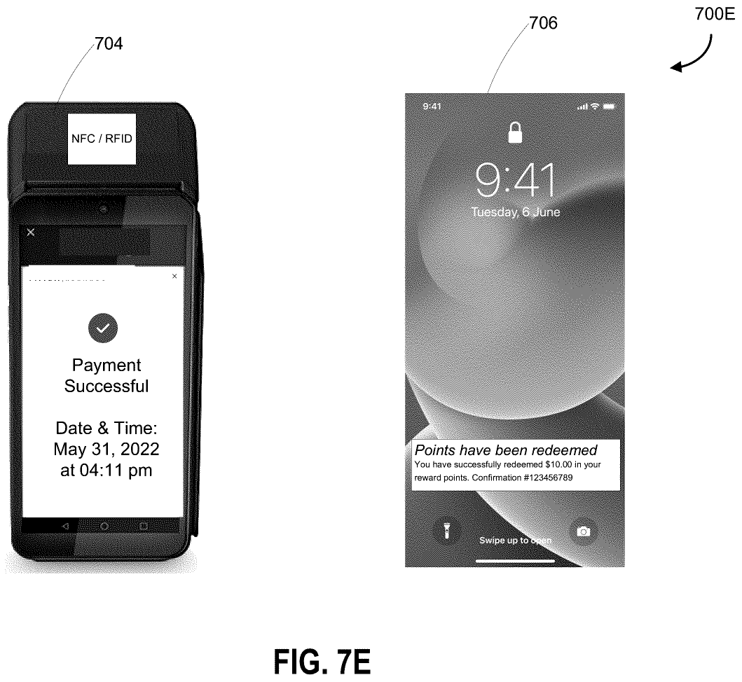

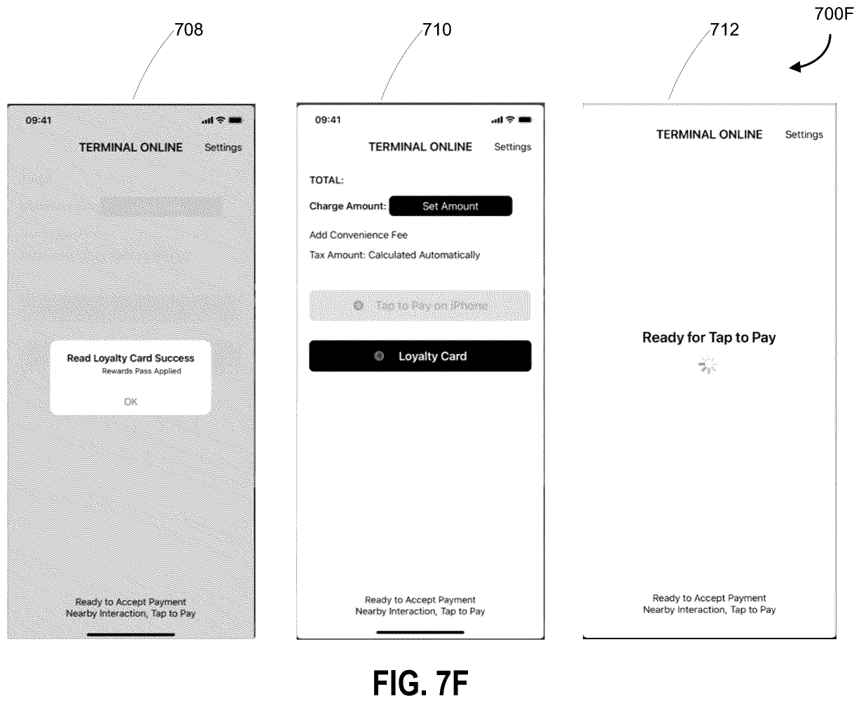

FIGS. 7A, 7B, 7C, 7D, 7E, 7F are example user interface renderings 700A, 700B, 700C, 700D, 700E, and 700F showing different segments of a non-limiting exemplar data message exchange process for conducting an electronic payment in accordance with some embodiments described herein.

The point of sale/payment terminal computing device 102 is capable of rendering specific user control instruction data sets which can prompt the user through the transaction.

The interactive graphical user interface controls 106 can be customized to provide the user with clear instructions through the electronic display screen 110 which controls the font colors, font size, style sheet and visual iconography.

In another embodiment, the third party remote database 122 can control the interactive graphical user interface controls 106 so that the third party may utilize their branding during the payment process.

In FIG. 7A, the point of sale/payment terminal computing device 102 renders the interactive user interface 104 onto the electronic display screen 110 so that the user is aware that they can proceed with the payment. The interactive graphical user interface controls 106 can be programmed to illustrate the purchase price and the different methods of payment which the point of sale/payment terminal computing device 102 is capable of accepting.

In FIG. 7B, the display screen of the user's mobile device is shown. The user has opened a payment application which includes a virtual banking card which allows the user to communicate with the point of sale/payment terminal computing device 102. The mobile device may communicate with the point of sale/payment terminal computing device 102 using near field communications through the reader locations on the point of sale/payment terminal computing device 102, or alternatively, through the QR code generated by the payment application on the mobile device.

In FIG. 7C, the point of sale/payment terminal computing device 102 renders the interactive user interface 104 onto the electronic display screen 110 so that the user is aware that the point of sale/payment terminal computing device 102 is capable of accepting an alternative payment method, and that the third party remote database 122 has confirmed to the processor 116 that the user has a positive balance of the alternative payment method. The interactive graphical user interface controls 106 can be programmed to provide instructions to the user on how to proceed with an alternative payment method.

In FIG. 7D, the point of sale/payment terminal computing device 102 renders the interactive user interface 104 onto the electronic display screen 110 with an option for the user to select the amount of points they wish to redeem for the purchase. The user can input their selection using the human interface device 112.

In FIG. 7E, the point of sale/payment terminal computing device 102 renders the interactive user interface 104 onto the electronic display screen 110 so that the user is aware that the transaction was complete. The interactive graphical user interface controls 106 can be programmed to render visual iconography to show that the transaction was successful and the date on which the transaction occurred, as seen in 704. The point of sale/payment terminal computing device 102 can be programmed to communicate using Bluetooth low energy through the processor 116, a message 706 to the users mobile device to notify them of the transaction and provide a digital receipt.

In FIG. 7F, the display screen of the user's mobile device is shown. The user has opened a payment application which includes a virtual banking card which allows the user to communicate with the point of sale/payment terminal computing device 102. The digital display on the user's mobile device in 708 will occur when the user has successfully transferred the payment data message 118 to the processor 116. The digital display on the user's mobile device in 710 illustrates the options provided to the user after the merchant has confirmed that the point of sale/payment terminal computing device 102 is capable of accepting an alternative payment method. The user may select the “Loyalty Card” option in order to send a payment data message 118 to the third party remote database 122 to reserve a portion of reward points for use in the transaction. The digital display on the user's mobile device in 712 illustrates instructions provided by the mobile banking application on the user's mobile phone to communicate the payment data message 118 with the point of sale/payment terminal computing device 102 using near field communications.

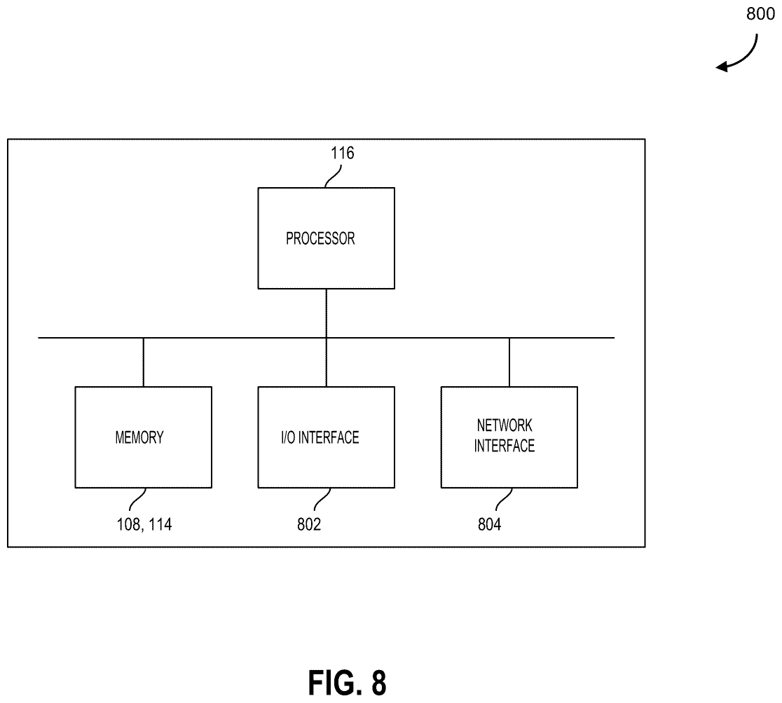

FIG. 8 is a computer diagram showing an example computing device, according to some embodiments.

System 800 may be a computer server for providing a gateway for communication between the point of sale/payment terminal computing device 102 to the third party remote database 122. The computing device 802 includes at least one processor 116, memory 108 and non-transitory computer readable storage media 114.

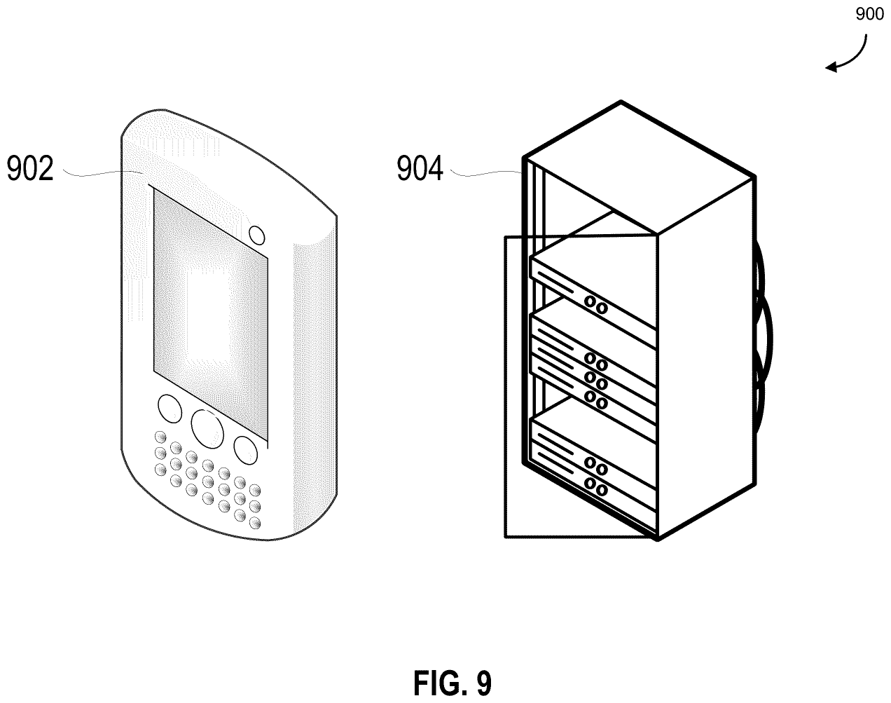

FIG. 9 is a computer diagram showing an example special purpose machine, according to some embodiments.

In FIG. 9, the special purpose machine 902 is a point of sale/payment terminal which incorporates features of the system 100. The special purpose machine 902 is a specially configured device having limited functionality and adapted to provide streamlined computing functions to a point of sale/payment terminal. In particular, the special purpose machine 902 is adapted solely to request payment on a user interface, receive payment information in the form of data message including a cryptogram, interface with a third party database server to validate and obtain rewards points information, and process a payment using one or both of reward points and funds. From a backend perspective, the special purpose machine 902 can be configured for settlement through requesting the equivalent funds from a payment system associated with the third party database after the third party database burns a corresponding amount of funds on its internal records.

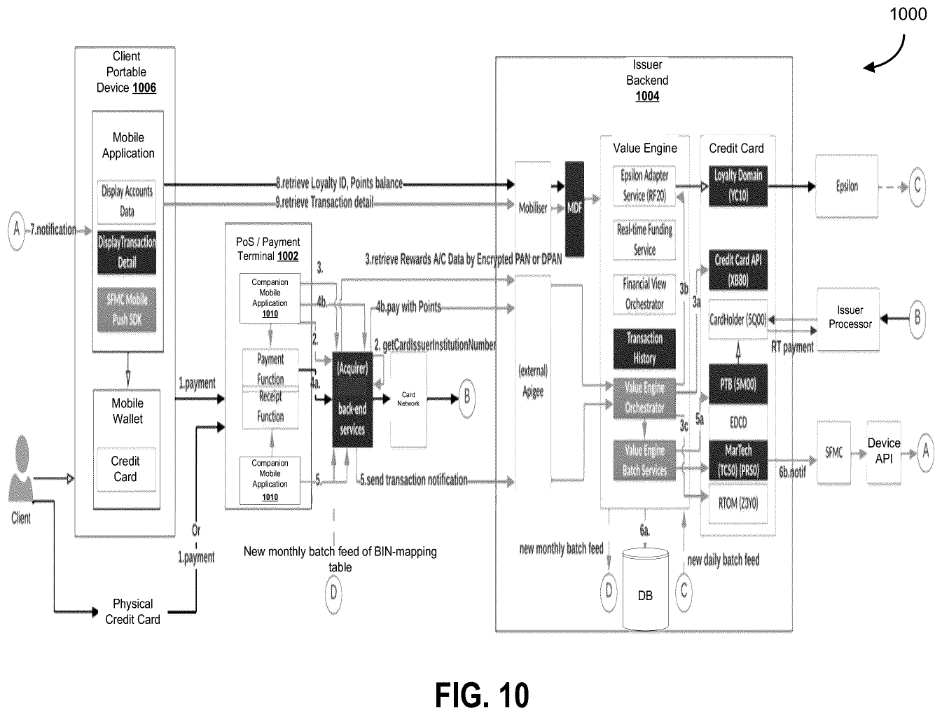

FIG. 10 is a computer architecture diagram 1000 showing interconnected computer systems and intersystem data message flows, according to some embodiments. A number of different steps are shown, labelled from 1-5. The steps for the data message flows are shown as examples and other variations are possible. In this example, software operating on a physical point of sale/payment terminal 1002 interoperates with issuer backend computing system 1004. The user's device 1006 is an optional device that can also be used as part of the redemption process, according to some embodiments, but in an alternate embodiment, the method steps can operate with just the physical point of sale/payment terminal 1002 and the issuer backend computing system 1004 (for example, if the user pays using a physical card through tap or insertion). The approach is used to provide interface element injection to enable the user to have the ability to redeem points for part of the basket total (when available point balance <purchase total), or for the entire basket total (when available point balance >=purchase total), according to different embodiments. Upon a successful transaction authorization, the transaction will be consummated using a spawned data message using the card information, and, points redemption can be processed, for example, as a real time statement credit. After payment completion, the user can be presented with final details (e.g. points used, card used) on the receipt, and synchronously or in some embodiments, asynchronously, with successful completion, the point balance is updated on a backend system to reflect redemption.

As shown in this example, in the proposed architecture and corresponding method, the companion mobile application 1010 operates on the point of sale/payment terminal, and is configured to operate simultaneously with the merchant point of sale/payment terminal mobile application 1008 such that both programs are loaded into memory and running on the physical point of sale/payment terminal. For example, the companion mobile application 1002 can be a side loaded mobile application, and the companion mobile application 1002 may be a specially configured smartphone device operating a smartphone application store/operating system backend.

The companion mobile application 1002 and the merchant point of sale/payment terminal mobile application 1008 interoperate with one another and the companion mobile application 1002 is callable by the point of sale/payment terminal through merchant point of sale/payment terminal mobile application 1008 to inject code or data objects as part of the user interface rendering flow and corresponding data message flow by the merchant point of sale/payment terminal mobile application 1008. The calling can be done using a function, GetCardIssuerInstitutionNumber—which returns the InstitutionNumber of the Credit Card to the POS App. This is used to determine whether the function is called. The proposed method for the terminal acquirer back-end is to return this number based on looking up from mapping tables locally at the acquirer back-end. The issuer can provide a monthly of batch file of BIN-mapping table (with PAN-prefixes and DPAN-prefixes) to maintain a Mapping table: “PAN-and-DPAN-prefix-to-institution”.

By injecting code or data objects, the payment process of the merchant point of sale/payment terminal mobile application 1006 is enhanced to enable additional payment options. The applications establish a trust relationship by leveraging a secret key exchange that is used between an acquirer backend system and individual point of sale/payment terminals/merchant point of sale/payment terminal mobile application 1008. The proxy makes calls with an issuer backend API with the same input parameters by first removing the POS terminal secret key parameter. The proxy interface can then establish a trust relationship with issuer APIs using an external API customer with OAuth client credential flow.
At Step 1, a payment data message is received, and in some embodiments, this payment data message can be a payload from a wallet application residing on the transmitted, for example, user's device 1006. The payment data message can also be a payload obtained from interrogating a chip card, a mag stripe, among others, instead of coming from the user's device 1006. The payment data message includes sensitive information, such as specific fields associated with authorization of payment transactions, such as a BIN, a PAN, a dPAN, among others. The payment data message can be interrogated by a receiver engine from the point of sale/payment terminal mobile application 1008 and stored as a set of credentials, encrypted on the point of sale/payment terminal local data storage, and a matching or verification data process can be run to first assess whether the payment data message corresponds with a participating issuer backend.
At Step 2, upon a positive determination that the payment data message corresponds with a participating issuer backend, the companion mobile application is called by the point of sale/payment terminal to inject code or data objects as part of the user interface rendering flow and corresponding data message flow by the point of sale/payment terminal.

The companion mobile application is configured to instantiate a plurality of communication channels using the available data network interfaces of the point of sale/payment terminal, the communication channels having different latency and security levels.
At Step 3a, Step 3b, and Step 3c, when the companion mobile application is called, for example, through a data message including details of a potential payment and a first encrypted sensitive identifier, the companion mobile application is configured to send an encrypted data message with the encrypted sensitive identifier or a variation thereof as a data payload to obtain a second identifier that is a less sensitive field. The second identifier, for example, could be a loyalty account number, whereas the first encrypted sensitive identifier could be a credit card number or other sensitive identifier that can be used as part of a payment authorization process.

The data message to send the first encrypted sensitive identifier, in some embodiments, is conducted across a higher security communication channel than subsequent communications due to the sensitivity of the information being transmitted. For returning the second identifier and subsequent communications, a reduced security level channel can be instantiated for usage. By using different security levels and a plurality of communication channels, the overall system and processing latency can be reduced, while also limiting the overall cybersecurity threat surface.

When the second identifier is obtained, the companion mobile application is configured to interact with the issuer backend computing system to determine whether additional prompts and user interface options are triggered, for example, based on award redemption conditions being met, user preferences, or other internal system logic. The additional prompts and user interface options are provided in the form of interface option data objects from the issuer backend computing system to the companion mobile application, which is configured to transform the interface option data objects into user interface screen rendering instructions to the point of sale/payment terminal device. In some embodiments, the interface option data objects are transformed into rendering code for consistency with a set of user interface style sheet parameters designated by the point of sale/payment terminal device. As noted above, the rendering code can modify font sizes, font selections button placement, a number of buttons, interaction type being exposed by the button (e.g., sliders, checkboxes), and other graphical design elements.

In a variant embodiment, the companion mobile application can also be configured to automatically determine the subset of options to be provided as the interface option data objects. The issuer backend computing system may provide eligibility information and total redemption options available, and the companion mobile application may convert these into quantized ranges or a subset of options based on rendering logic stored thereon in memory allocated for the companion mobile application. For example, the companion mobile application may control the rendering of 2-3 redemption options in the form of interactive/interfaceable buttons.

In another variant described herein, the eligibility information may be combined with characteristics identified by the companion mobile application before generating the subset of available options, such that a triggering requirement may require a combination of triggering characteristics from the issuer backend computing system and the companion mobile application or the point of sale/payment terminal device. In a further variant embodiment, the issuer backend computing system is configured to interoperate with a confidential computing backend for determining whether a particular user identifier is located on a confidential computing generated audience list for a particular offer or promotion. These offers or promotions can be returned as part of a data message payload from the issuer backend computing system.

Following the selection of a redemption option of the plurality of redemption options presented by the user interface, the selection identified through processed user inputs, at Steps 4a and 4b child transaction messages are spawned to the issuer backend computing system, a first child transaction message conducting the payment transaction for the value of the object or service being purchased in accordance with payment rails of the point of sale/payment terminal device using the first identifier to be sent over the higher security communication channel, and a second child transaction message using the second identifier corresponding to the redemption option to be sent over the lower security communication channel. In some embodiments, to improve response time, Steps 4b and Step 5 can be consolidated into one single call Step 5.

In some embodiments, the timing of the first child transaction message and the second child transaction message can be controlled by the companion mobile application such that the first child transaction message and the second child transaction message are conducted asynchronously. For example, the first child transaction message can be triggered to be sent as soon as possible on a high priority channel, while the second child transaction message can be sent shortly during a period of availability (e.g., as measured by network performance) on a lower priority channel. In a further variation, the second child transaction message can be bundled with other second child transaction message for sending across a bundled data object for periodic clearance and settlement to reduce the overall network communications overhead requirements.

At Step 5, 5a, 6a and 6b, both of the spawned transactions including the potential redemption are recorded and made available through a device API so that an accurate record of the transactions can be established. Where there are multiple spawned transactions, a sanity check can be utilized to ensure that the amounts can be reconciled. In some embodiments, a full payment is made for the full value of the item, with the second spawned transaction providing either a real-time reimbursement, or an asynchronous but still relatively temporally proximate (e.g., within 5 minutes) reimbursement. In another embodiment, the payments are balanced off against one another and instead, in Steps 6a and 6b, the payment is only made for the reduced amount, if applicable (there may be situations where the payment is not made at all, such as when there is a full reimbursement available using points). At Steps 7, 8, and 9, optionally the client's portable device and corresponding mobile application can be updated and retrieve a most recently updated points balance and transaction detail from the issuer backend computing system 1004.

A cybersecurity enhanced data message flow is shown across all steps that is adapted to use two separate communication channels having different cryptographic security levels to improve overall latency impacts of the data messages. Reducing system latency aids in smoothing a user experience, especially as latency effects compound in highly scaled environments where a large number of point of sale/payment terminal devices are conducting a large number of temporally proximate or simultaneous transactions for a large number of users. This type of highly scaled environment can include high throughput/low margin businesses, such as grocery shopping, among others, where latency effects can slow down the speed at which user purchases can be processed by cashiers.

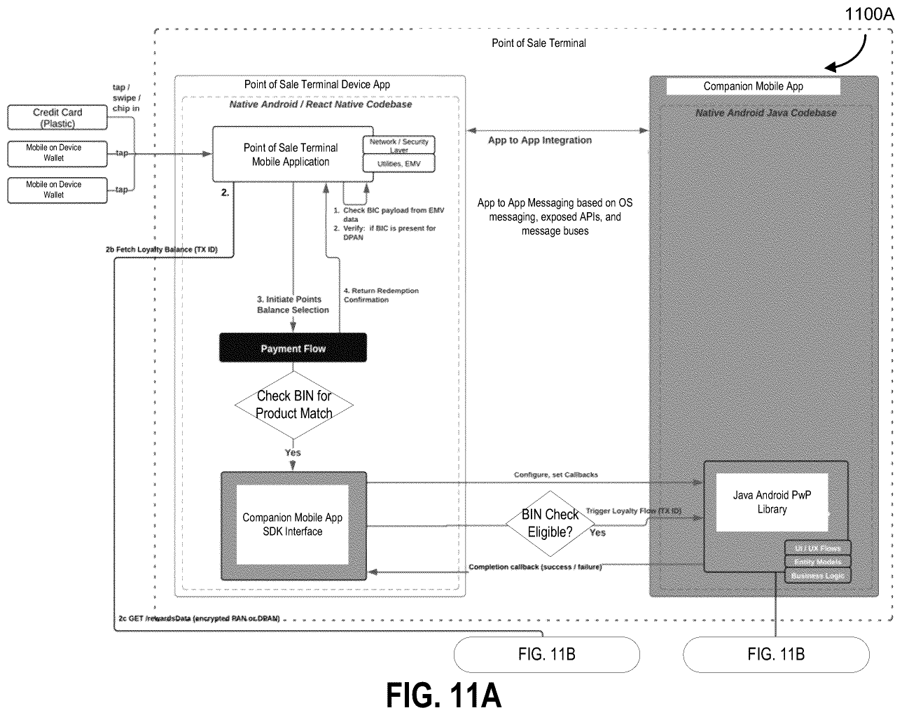

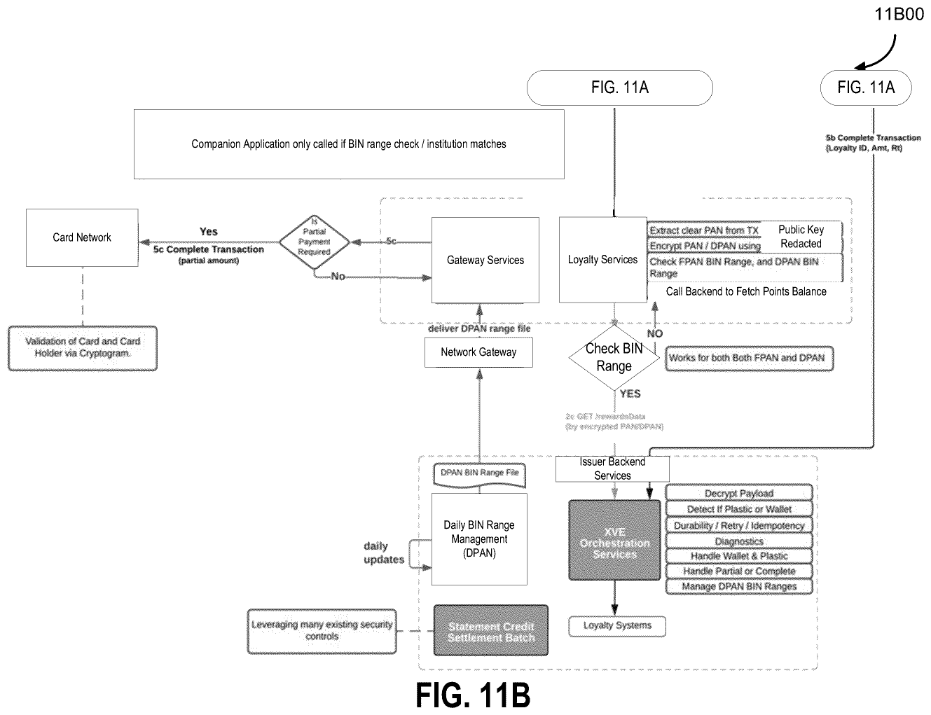

FIG. 11A is a computer architecture diagram 1100A showing a companion mobile application operating alongside a point of sale/payment terminal mobile application on the point of sale/payment terminal device, according to some embodiments. FIG. 11B is a continuation of the computer architecture diagram 1100A at 1100B of showing a companion mobile application operating alongside a point of sale/payment terminal mobile application on the point of sale/payment terminal device. In these diagrams, the method steps are now shown from the perspective of the point of sale terminal, in more detail. The Steps from 1-5b show example steps to check if a particular identifier is related to a particular participating issuer, in which case the flow from FIG. 10 is invoked to utilize the associated companion mobile application to establish secure channels for secure communication.

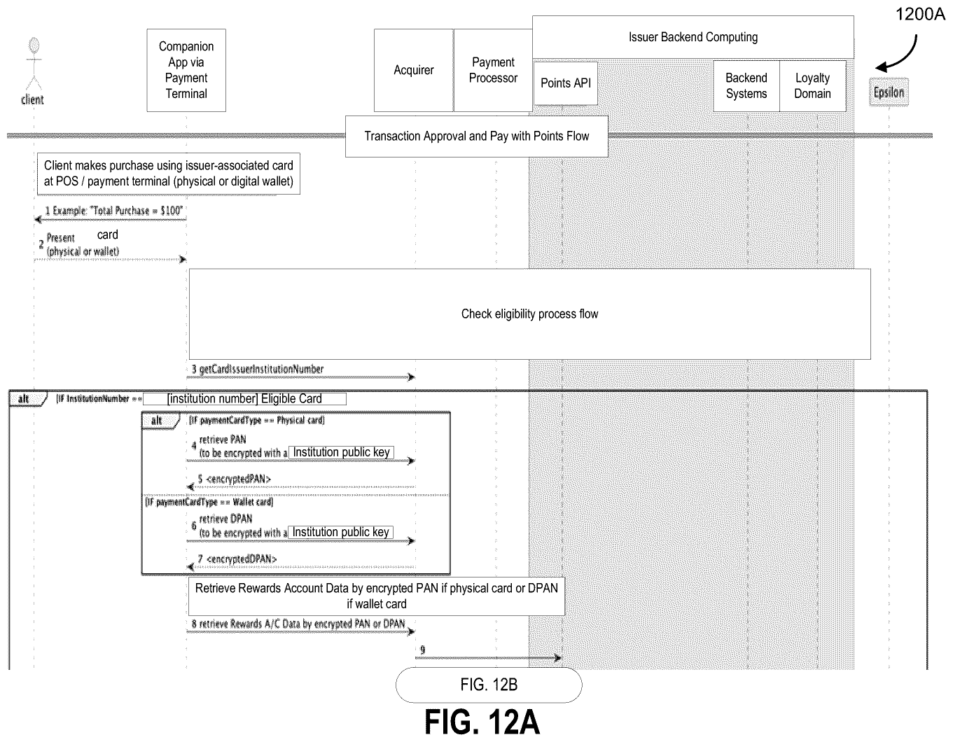

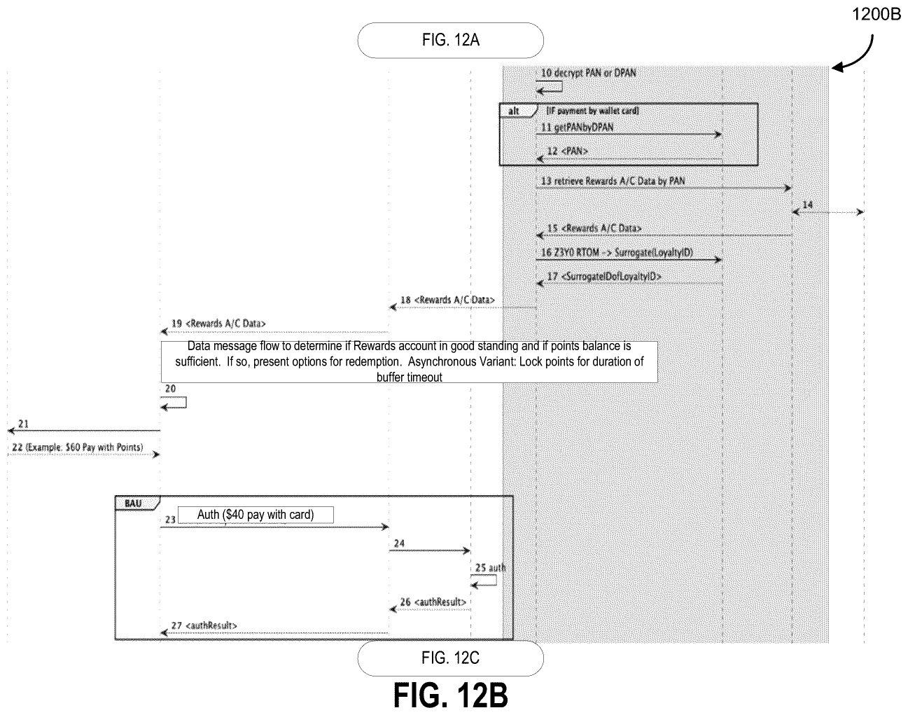

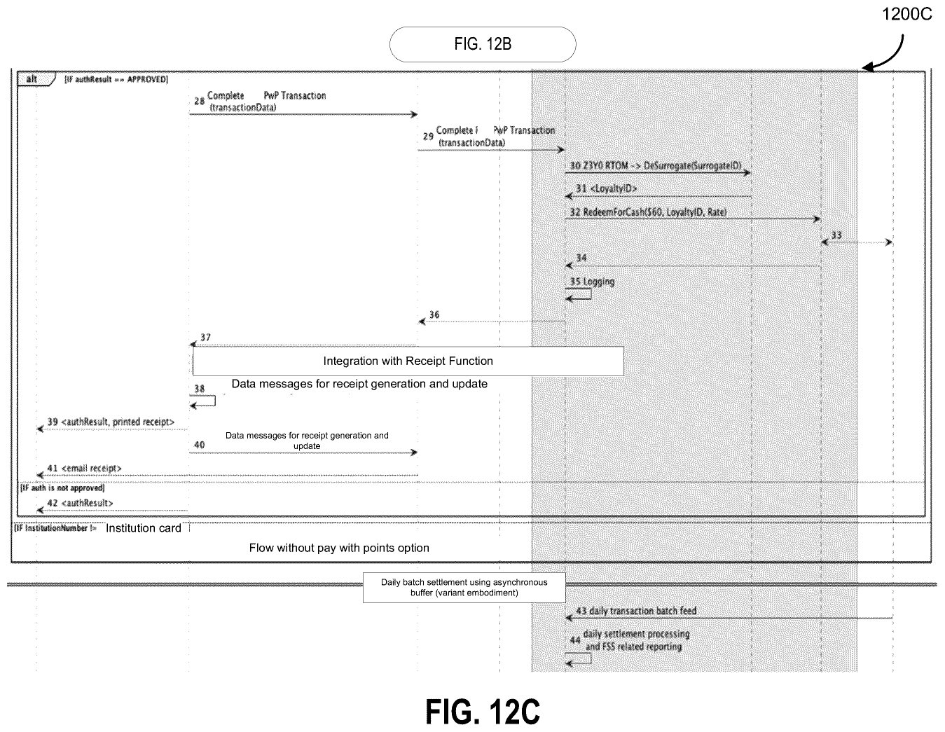

FIG. 12A is a process diagram 1200A showing example steps of a method for interprocess communications, according to some embodiments. FIG. 12B is a continuation 1200B of the process diagram showing example steps of a method for interprocess communications, according to some embodiments. FIG. 12C is a continuation 1200C of the process diagram showing example steps of a method for interprocess communications, according to some embodiments. Similar steps as to those shown in FIG. 10 are provided.

Different entry points are possible, such as an example A, where a customer enters merchant store and is prompted with a pay with points (PWP) flow on terminal upon payment. In another variation, Example B, a customer receives a notification from an application on their mobile phone and heads straight to Merchant store without opening app. Customer is prompted with PWP flow on terminal upon payment. In this example, there may be an enhanced reward or redemption that can be attached and triggered during the PWP flow. In another example C.1, the customer receives notification from the mobile application about nearby merchant eligible for PWP and views it in-app. Customer enters merchant store and is prompted with PWP flow on terminal upon payment. In another Example D, a customer receives notification from their mobile application on their personal device about several merchants eligible for PWP nearby and views list in-app. Customer enters preferred merchant store and is prompted with PWP flow on terminal upon payment. In these examples, the user can either be reimbursed immediately, the amount can be offset, or a statement credit can be generated in near real time.

In all of these examples, the PWP flow is conducted through a combination of the applications residing on the payment terminal/point of sale device working together. The payment terminal/point of sale device, upon receiving a payment card token, can interrogate the token immediately to determine whether the companion mobile application should be invoked. This can be done by interrogating the BIN number, for example.

A challenge with all of these flows is that the additional communications to the backend and accordingly, additional communication overhead is needed, and in specific embodiments described herein, asynchronous messaging, buffering, and lower security channels are proposed as mechanisms to reduce overall messaging overhead while maintaining a high service level and security level for any communications where the data payload includes payment information datagrams.

In particular, Steps 1-3 relate to obtaining the payment data object, steps 4-7 relate to the secure channel communications using sensitive data fields, and steps 8-20 relate to using the second identifier field (in this example, loyaltyID) to interface with the issuer backend to avoid sending highly sensitive payment information in subsequent communications with the issuer backend computing system. After Step 20, a series of potential redemption options are provided by the mobile companion app and injected into the user interface flow being presented by a user interface rendered on the point of sale device/payment terminal. The user makes a selection by interacting with a user interface control at Step 22, and two child transactions are spawned in this example, at Steps 23-27 for a highly secure payments transaction with a first child transaction, and at Steps 28-39 for the second child transaction, which is the lower security “pay with points” transaction that does not use the sensitive data field and thus can be conducted asynchronously (e.g., placed into a buffer to be executed along with a grouping of other pay with points child transaction messages when the buffer is flushed to reduce messaging overhead). While in the example Steps 23-39, the points were used to reduce the total transaction value in the first child transaction, as noted above, other variations are possible where the first child transaction is for the full value and the second child transaction also includes the triggering of an instant reimbursement. Steps 40-44 are directed to generating receipts, records for settlement, and reconciliations.

In a set of variant approaches, while payment implementation examples are described, the approach can be used as a data communications/messaging framework that can be used in use cases beyond payments. The chained services provisioning means that not only payments can be conducted using points, but extended functionality can also include, either in addition to or instead of points redemption, sending of receipts, unlocking of devices, among others, through a sequence of electronic steps that could automatically happen that are dependent on the previous step where a workflow is initiated.

For example, when using a “payment device”, there is an ability to use a Consumer Device Cardholder Verification Method (CDCVM) which will allow the mechanism to better secure the transactions through authentication (e.g., biometric, device handshake, PIN, etc.).

The framework can also support other 3rd party services like points earn, budget loading of transactions, chain-event-transactions like “pair-start-service” (for example, where the customer cannot have a propane tank filled until the customer pays inside. This can be used to assist in approaches where the customer can automatically be placed into a queue for services so that the customer does not need to wait an extra period of time. The customer can be inserted into a queue based on time of payment. In this example, the extended functionality could be that the third party remote database is used for communications with the propane filling queue data record, which could be connected to a user interface display screen showing who is next in the queue and their payment status. As a practical example, a customer would thus be able to use the system to pay for propane in store, which electronically triggers an attendant to start filling instead of the attendant waiting for a person to produce a receipt in person. These workflows can automatically be triggered upon the message flow to the third party backend server through the application programming interface. In this example, the customer “taps” or “inserts” once, and they are automatically identified and their underlying account on the third party database can be accessed to identify a corresponding account having an enabled option (e.g., a flag data field). When the customer completes the purchase, or even beforehand, instead of or in addition to a redemption of points being conducted, a chained workflow is initiated, which can start a fueling process for a propane tank, for example. This extended functionality allows secure integration with electronic devices that may be available for interconnection with the point of sale/payment terminal computing device that can be flexibly integrated despite being part of a separate cyber security ecosystem than the point of sale/payment terminal computing device.

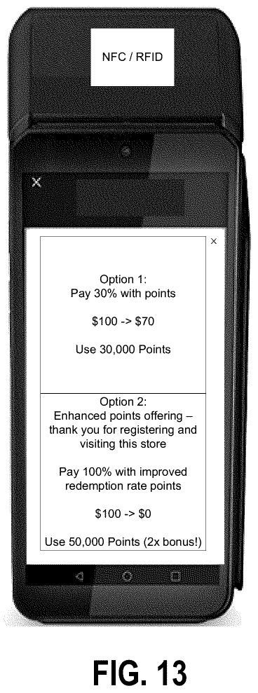

FIG. 13 is an example user interface showing a number of different rendered UI elements, according to some embodiments. As shown in FIG. 13, there are three potential UI options that are available for redemption. When the companion application receives the data object from the issuer with set of available promotions and/or points balances, the data object can include additional fields relating to user preferences (e.g., user does not wish to participate), or based on specific logic/UI rendering from the backend issuer platform (e.g., user has conducted multiple redemptions in a period of time and should not be shown the screen any more times). In another variation, the three potential UI options can also include enhanced promotions based on a triggered set of conditions where specific promotions the user has registered for, are located on a desired audience list for.

The triggering conditions can be returned in the data object as a set of conditions that require both triggering conditions determined based on the point of sale/payment terminal characteristics (e.g., payment terminal number corresponding to location/merchant, GPS coordinates) that are provided to the companion mobile application. In terms of the audience list or available promotions, these can be validated on the issuer backend based on a lookup table or other relational database record of registrations. An example scenario could be where a user has been incentivized to visit a store through the client's portable device providing a notification and a location-based promotion. In this example, location based offers are available that provide a first enhanced redemption or promotion if the user goes to a specific store or participating retailer, which will be identified by a payment terminal number or merchant identifier by the mobile companion application during the payment process. The location based offers can be coupled with navigation instructions and/or mapping instructions.

In some embodiments, the audience list is a set of characteristics that are generated by a coupled campaign manager process to the issuer backend system. The audience list, for example, can be associated with specific conditions from a confidential joined database table operating on a confidential computing platform. A confidential query may be executed on the joined database table and an eligibility flag may be associated with particular loyalty accounts. The issuer backend system can utilize the output audience list to generate specific targeted promotions for rendering on the user interface screen.

Corresponding methods, computer program programs are contemplated. The computer program products can be physically affixed in the form of articles of manufacture, such as non-transitory computer readable media stored thereon having machine interpretable instructions that are executable by a computer processor. Upon execution by the computer processor, the processor performs steps of a method for data process integration as described in various embodiments herein.

Applicant notes that the described embodiments and examples are illustrative and non-limiting. Practical implementation of the features may incorporate a combination of some or all of the aspects, and features described herein should not be taken as indications of future or existing product plans. Applicant partakes in both foundational and applied research, and in some cases, the features described are developed on an exploratory basis.

The term “connected” or “coupled to” may include both direct coupling (in which two elements that are coupled to each other contact each other) and indirect coupling (in which at least one additional element is located between the two elements).

Although the embodiments have been described in detail, it should be understood that various changes, substitutions and alterations can be made herein without departing from the scope. Moreover, the scope of the present application is not intended to be limited to the particular embodiments of the process, machine, manufacture, composition of matter, means, methods and steps described in the specification.

As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the embodiments are intended to include within their scope such processes, machines, manufacture, compositions of matter, means, methods, or steps.

As can be understood, the examples described above and illustrated are intended to be exemplary only.

What is claimed is:

1. A point of sale computing device (102) for rendering an interactive user interface (104) including one or more interactive graphical user interface controls (106), the point of sale computing device (102) including:
a computer memory (108);
an electronic display screen (110) displaying the interactive user interface (104);
a human interface device (112) for receiving user interface inputs from a user;
non-transitory computer readable storage media (114);
a processor (116) configured to:
receive a payment data message (118) including at least a payment data cryptogram (120) representing a payment token data structure, the payment token data structure including at least one data field indicative of a linkage with a third party remote database (122) storing one or more data records corresponding to one or more alternative payment options;
validate, through communication of secure messaging with an application programming interface of the third party remote database (122), a confirmed enrollment and an availability of the one or more alternative payment options on the one or more data records;
control rendering, on the electronic display screen (110), the one or more interactive graphical user interface controls (106), the one or more interactive graphical user interface controls (106) corresponding to the one or more alternative payment options and providing a prompt for a user to select either a partial payment or a full payment using the one or more alternative payment options;
receive, through the human interface device (112), an indication that the user has selected either the partial payment or the full payment using the one or more alternative payment options; and
transmit, through the application programming interface of the third party remote database (122), a redemption data message (124) including a redemption data cryptogram indicating the selection of the one or more alternative payment options.

2. The point of sale computing device (102) of claim 1, wherein the application programming interface of the third party remote database (122) is configured to return one or more user interface style sheets that control one or more visual configurations of the one or more interactive graphical user interface controls (106).

3. The point of sale computing device (102) of claim 1, wherein the secure messaging with the application programming interface of the third party remote database (122) includes establishing a secure channel using a secure cryptographic handshake for authenticating an identity of the user.

4. The point of sale computing device (102) of claim 3, wherein the secure messaging with the application programming interface of the third party remote database (122) further includes using the secure cryptographic handshake for reserving in the one or more data records a quantity of payment tokens corresponding to the full payment for a duration of time.

5. The point of sale computing device (102) of claim 4, wherein the at least one data field indicative of the linkage with a third party remote database (122) includes at least one cryptographic secret that enables a limited authentication of the identity of the user, and the at least one cryptographic secret is utilized for securing the secure cryptographic handshake.

6. The point of sale computing device (102) of claim 5, wherein the secure cryptographic handshake includes a confirmation of the reserving in the one or more data records the quantity of payment tokens corresponding to the full payment for the duration of time.

7. The point of sale computing device (102) of claim 6, wherein the redemption data message (124) includes the at least one cryptographic secret and a data field indicative of an amount of redemption, wherein a backend computer server, upon receiving the redemption data message (124), processes the redemption data message (124) and releases a reservation corresponding to the reserving in the one or more data records of the quantity of payment tokens corresponding to the full payment for the duration of time.

8. The point of sale computing device (102) of claim 7, wherein the redemption data message is generated for asynchronously processing relative to processing of a corresponding a spawned payment message, the redemption data message (124) being buffered with one or more other redemption data messages for batch processing.

9. The point of sale computing device (102) of claim 8, wherein the redemption data message is transmitted over a separate, lower security communications channel than the corresponding spawned payment message.

10. The point of sale computing device (102) of claim 1, wherein the point of sale computing device (102) is a portable handheld device running a first mobile application configured for interfacing with the application programming interface of the third party remote database (122) and a second mobile application configured for processing the payment data message (118), the first mobile application and the second mobile application virtually segregated from one another.

11. A computer implemented method for controlling a point of sale computing device (102) to render an interactive user interface (104) including one or more interactive graphical user interface controls (106), method comprising:
receiving a payment data message (118) including at least a payment data cryptogram (120) representing a payment token data structure, the payment token data structure including at least one data field indicative of a linkage with a third party remote database (122) storing one or more data records corresponding to one or more alternative payment options;
validating through communication of secure messaging with an application programming interface of the third party remote database (122), a confirmed enrollment and an availability of the one or more alternative payment options on the one or more data records;
controlling rendering, on the electronic display screen (110), the one or more interactive graphical user interface controls (106), the one or more interactive graphical user interface controls (106) corresponding to the one or more alternative payment options and providing a prompt for a user to select either a partial payment or a full payment using the one or more alternative payment options;
receiving through the human interface device (112), an indication that the user has selected either the partial payment or the full payment using the one or more alternative payment options; and
transmitting through the application programming interface of the third party remote database (122), a redemption data message (124) including a redemption data cryptogram indicating the selection of the one or more alternative payment options.

12. The method of claim 11, wherein the application programming interface of the third party remote database (122) is configured to return one or more user interface style sheets that control one or more visual configurations of the one or more interactive graphical user interface controls (106).

13. The method of claim 11, wherein the secure messaging with the application programming interface of the third party remote database (122) includes using a secure cryptographic handshake for authenticating an identity of the user.

14. The method of claim 13, wherein the secure messaging with the application programming interface of the third party remote database (122) includes using the secure cryptographic handshake for reserving in the one or more data records a quantity of payment tokens corresponding to the full payment for a duration of time.

15. The method of claim 14, wherein the at least one data field indicative of the linkage with a third party remote database (122) includes at least one cryptographic secret that enables a limited authentication of the identity of the user, and the at least one cryptographic secret is utilized for securing the secure cryptographic handshake.

16. The method of claim 15, wherein the secure cryptographic handshake includes a confirmation of the reserving in the one or more data records the quantity of payment tokens corresponding to the full payment for the duration of time.

17. The method of claim 16, wherein the redemption data message (124) includes the at least one cryptographic secret and a data field indicative of an amount of redemption, wherein a backend computer server, upon receiving the redemption data message (124), processes the redemption data message (124) and releases a reservation corresponding to the reserving in the one or more data records of the quantity of payment tokens corresponding to the full payment for the duration of time.

18. The method of claim 17, wherein the redemption data message is generated for asynchronously processing relative to processing of a corresponding a spawned payment message, the redemption data message (124) being buffered with one or more other redemption data messages for batch processing.

19. The method of claim 18, wherein the redemption data message is transmitted over a separate, lower security communications channel than the corresponding spawned payment message.

20. A non-transitory computer readable medium or computer program product storing machine interpretable instructions, which when executed by a processor, cause the processor to perform steps of a method for controlling a point of sale computing device (102) to render an interactive user interface (104) including one or more interactive graphical user interface controls (106), method comprising:
receiving a payment data message (118) including at least a payment data cryptogram (120) representing a payment token data structure, the payment token data structure including at least one data field indicative of a linkage with a third party remote database (122) storing one or more data records corresponding to one or more alternative payment options;
validating through communication of secure messaging with an application programming interface of the third party remote database (122), a confirmed enrollment and an availability of the one or more alternative payment options on the one or more data records;
controlling rendering, on the electronic display screen (110), the one or more interactive graphical user interface controls (106), the one or more interactive graphical user interface controls (106) corresponding to the one or more alternative payment options and providing a prompt for a user to select either a partial payment or a full payment using the one or more alternative payment options;
receiving through the human interface device (112), an indication that the user has selected either the partial payment or the full payment using the one or more alternative payment options; and
transmitting through the application programming interface of the third party remote database (122), a redemption data message (124) including a redemption data cryptogram indicating the selection of the one or more alternative payment options.
